(19) United States
(12) Patent Application Publication
(10) Pub. No.: US 2023/0416437 A1
(43) Pub. Date: Dec. 28, 2023

(54) POLYMERIZABLE COMPOSITION AND DECORATIVE FILM

(71) Applicant: FUJIFILM CORPORATION, Tokyo (JP)

(72) Inventors: Yuko SUZUKI, Kanagawa (JP); Hiroshi INADA, Kanagawa (JP); Chihiro MASUDA, Kanagawa (JP); Shunya KATOH, Kanagawa (JP)

(21) Appl. No.: 18/346,788

(22) Filed: Jul. 4, 2023

Related U.S. Application Data
(63) Continuation of application No. PCT/JP2022/008335, filed on Feb. 28, 2022.

(30) Foreign Application Priority Data
Mar. 12, 2021 (JP) 2021-040322

(51) Int. Cl. C08F 236/20; C09D 129/04

(52) U.S. Cl. CPC C08F 236/20; C09D 129/04

(57) ABSTRACT

Provided are a polymerizable composition containing a liquid crystal compound represented by Formula (1) and a chiral compound, in which a proportion of a total amount of a compound including one polymerizable group is 60% by mass or more with respect to a total amount of a compound including at least one polymerizable group; and an application thereof.

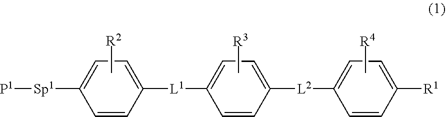

### CROSS-REFERENCE TO RELATED APPLICATIONS

This application is a continuation application of International Application No. PCT/JP2022/008335, filed Feb. 28, 2022, the disclosure of which is incorporated herein by reference in its entirety. Further, this application claims priority from Japanese Patent Application No. 2021-040322, filed Mar. 12, 2021, the disclosure of which is incorporated herein by reference in its entirety.

### BACKGROUND OF THE INVENTION

### 1. Field of the Invention

The present disclosure relates to a polymerizable composition and a decorative film.

### 2. Description of the Related Art

A polymerizable composition containing a liquid crystal compound (preferably a liquid crystal compound including a polymerizable group) has been used, for example, for forming various liquid crystal phases such as a cholesteric liquid crystalline phase. For example, a layer including the cholesteric liquid crystalline phase (that is, a cholesteric liquid crystal layer) has been used as constituent elements of various articles such as a projection member (for example, WO2017/199812A), a liquid crystal color filter (for example, JP2002-338668A), and a decorative film (for example, WO2018/146995A). The polymerizable group of the liquid crystal compound undergoes a curing reaction (for example, polymerization and crosslinking) to maintain an alignment of the liquid crystal compound forming the liquid crystal phase.

### SUMMARY OF THE INVENTION

The following improvements are required with respect to properties of the polymerizable composition. For example, there is a demand for improving stretchability of a cured substance obtained by curing the polymerizable composition. In addition, there is also a demand for reducing defects in the liquid crystal phase in the cured substance obtained by curing the polymerizable composition. For example, in a decorative film including the liquid crystal layer obtained by curing the polymerizable composition, a decrease in stretchability of the liquid crystal layer may lead to a decrease in followability of the decorative film to an object to be decorated, and the defects in the liquid crystal phase may lead to deterioration in reflection characteristics.

An object of an embodiment of the present disclosure is to provide a polymerizable composition which forms a cured substance with excellent stretchability and reduced defects in a liquid crystal phase. An object of another embodiment of the present disclosure is to provide a decorative film formed of the polymerizable composition.

The present disclosure includes the following aspects.

<1> A polymerizable composition comprising:
a liquid crystal compound represented by Formula (1); and
a chiral compound,
in which a proportion of a total amount of a compound including one polymerizable group is 60% by mass or more with respect to a total amount of a compound including at least one polymerizable group.

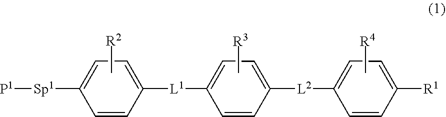

In Formula (1), R¹ to R⁴ each independently represent a hydrogen atom, an alkyl group having 1 to 20 carbon atoms, a group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—, or —CN, where at least one of R², R³, or R⁴ is a substituent which is not a hydrogen atom,

L¹ and L² each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, or —C≡C—,

Sp¹ represents a single bond, an alkylene group having 1 to 20 carbon atoms, or a group having a structure in which at least one —CH₂— in an alkylene group having 2 to 20 carbon atoms is substituted with —O—, —S—, —NH—, —N(CH₃)—, —C(═O)—, —OC(═O)—, or —C(═O)O—, and

P¹ represents a polymerizable group represented by Formula (P-1) or Formula (P-2).

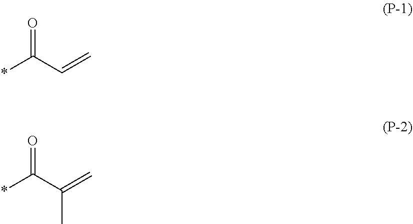

In Formula (P-1) and Formula (P-2), * represents a bonding position.

<2> The polymerizable composition according to <1>,

in which, in Formula (1), at least one of R² or R³ is an alkyl group having 1 to 10 carbon atoms, an alkoxy group having 1 to 10 carbon atoms, —COOX¹, or —COX², where X¹ and X² each independently represent a linear alkyl group having 1 to 20 carbon atoms or a branched alkyl group having 3 to 20 carbon atoms.

<3> The polymerizable composition according to <1>,

in which, in Formula (1), at least one of R² or R³ is —COOX¹ or —COX², where X¹ and X² each independently represent a linear alkyl group having 1 to 20 carbon atoms or a branched alkyl group having 3 to 20 carbon atoms.

<4> The polymerizable composition according to <1>,

in which, in Formula (1), R³ is —COOX³, where X³ represents a linear alkyl group having 1 to 20 carbon atoms or a branched alkyl group having 3 to 20 carbon atoms.

<5> The polymerizable composition according to <1>,

in which the liquid crystal compound represented by Formula (1) is a liquid crystal compound represented by Formula (1-1).

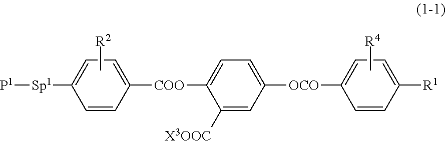

In Formula (1-1), R¹ has the same meaning as R¹ in Formula (1), R² has the same meaning as R² in Formula (1), R⁴ has the same meaning as R⁴ in Formula (1), Sp¹ has the same meaning as Sp¹ in Formula (1), P¹ has the same meaning as P¹ in Formula (1), and X³ represents a linear alkyl group having 1 to 20 carbon atoms or a branched alkyl group having 3 to 20 carbon atoms.

<6> The polymerizable composition according to any one of <1> to <5>,

in which the chiral compound includes a chiral compound represented by Formula (2).

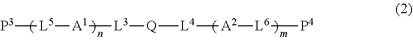

In Formula (2), L³ to L⁶ each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, —C≡C—, or —N═N—,

A¹ and A² each independently represent a hydrocarbon ring group or a hetero ring group,

P³ and P⁴ each independently represent a hydrogen atom, an alkyl group having 1 to 20 carbon atoms, a group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—, —CN, or -Sp²-P⁵, where Sp² represents a single bond, an alkylene group having 1 to 20 carbon atoms, or a group in which at least one —CH₂— in an alkylene group having 2 to 20 carbon atoms is substituted with —O—, —S—, —NH—, —N(CH₃)—, —C(═O)—, —OC(═O)—, or —C(═O)O—, P⁵ represents a polymerizable group represented by Formula (P-3) or Formula (P-4), and at least one of P³ or P⁴ is -Sp²-P⁵,

Q represents a divalent chiral source, and

n and m each independently represent an integer of 1 to 3, where, in a case where n or m is an integer of 2 or more, a plurality of A¹'s may be the same or different from each other, a plurality of A²'s may be the same or different from each other, a plurality of L's may be the same or different from each other, and a plurality of L⁶'s may be the same or different from each other.

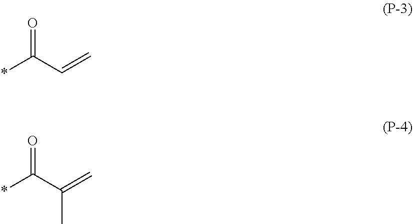

In Formula (P-3) and Formula (P-4), * represents a bonding position.

<7> The polymerizable composition according to <6>,

in which, in Formula (2), at least one of L³, . . . , or L⁶ is —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, or —N═N—.

<8> The polymerizable composition according to <6>,

in which, in Formula (2), at least one of L³, . . . , or L⁶ is —CH═CH—COO—, —OCO—CH═CH—, —CH═C(CN)—COO—, or —OCO—C(CN)═CH—.

<9> The polymerizable composition according to any one of <6> to <8>,

in which, in Formula (2), Q is a divalent chiral source including a binaphthyl skeleton, an isosorbide skeleton, or an isomannide skeleton.

<10> The polymerizable composition according to any one of <6> to <9>,

in which, in Formula (2), Q is a divalent chiral source represented by Formula (Q-1) or Formula (Q-2).

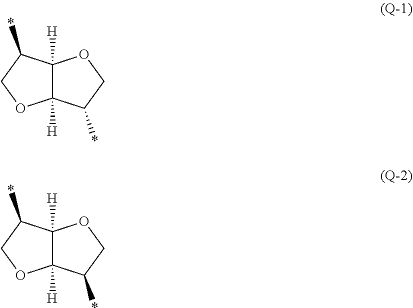 [SMILES: *[C@@H]1CO[C@H]2[C@@H]1OC[C@@H]2* ; *[C@@H]1CO[C@H]2[C@@H]1OC[C@H]2*]

In Formula (Q-1) and Formula (Q-2), * represents a bonding position.

<11> The polymerizable composition according to any one of <6> to <10>,

in which the chiral compound represented by Formula (2) is a chiral compound represented by Formula (2-1) or Formula (2-2).

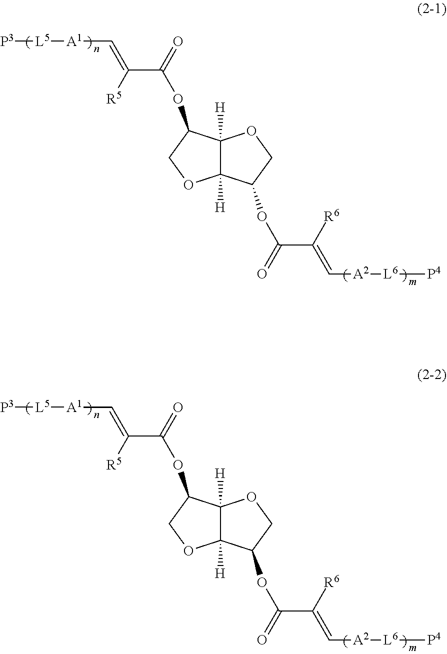

In Formula (2-1) and Formula (2-2), L⁵ has the same meaning as L⁵ in Formula (2), L⁶ has the same meaning as L⁶ in Formula (2), A¹ has the same meaning as A¹ in Formula (2), A² has the same meaning as A² in Formula (2), P³ has the same meaning as P³ in Formula (2), P⁴ has the same meaning as P⁴ in Formula (2), n has the same meaning as n in Formula (2), m has the same meaning as m in Formula (2), and R⁵ and R⁶ each independently represent a hydrogen atom, —CN, or an alkyl group having 1 to 10 carbon atoms.

<12> The polymerizable composition according to <11>,

in which, in Formula (2-1) or Formula (2-2), R⁵ and R⁶ are —CN.

<13> A decorative film comprising:

a layer obtained by curing the polymerizable composition according to any one of <1> to <12>.

According to an embodiment of the present disclosure, there is provided a polymerizable composition which forms a cured substance with excellent stretchability and reduced defects in a liquid crystal phase. According to another embodiment of the present disclosure, there is provided a decorative film formed of the polymerizable composition.

### DESCRIPTION OF THE PREFERRED EMBODIMENTS

Hereinafter, embodiments of the present disclosure will be described in detail. The present disclosure is not limited to the following embodiments. The following embodiments may be modified as appropriate within the scope of the purposes of the present disclosure.

The numerical range indicated by using “to” in the present disclosure indicates a range including numerical values described before and after “to” as a lower limit value and an upper limit value, respectively. Regarding numerical ranges which are described stepwise in the present disclosure, an upper limit value or a lower limit value described in a numerical range may be replaced with an upper limit value or a lower limit value of another stepwise numerical range. In addition, in the numerical ranges described in the present disclosure, an upper limit value and a lower limit value described in a numerical range may be replaced with values shown in Examples.

In the present disclosure, in a case where a plurality of substances corresponding to each component in a composition is present, the amount of each component in the composition means the total amount of the plurality of substances present in the composition, unless otherwise specified.

In the present disclosure, a term “step” denotes not only an individual step but also a step which is not clearly distinguishable from another step as long as an effect expected from the step can be achieved.

In the present disclosure, “% by mass” has the same definition as that for “% by weight”, and “part by mass” has the same definition as that for “part by weight”.

In the present disclosure, “(meth)acrylate” includes acrylate and methacrylate.

In the present disclosure, “(meth)acrylic” includes acrylic and methacrylic.

In the present disclosure, “solid content” means a component other than a solvent. A liquid component which does not correspond to the solvent is regarded as the solid content.

In the present disclosure, a group (atomic group) to which a term “substituted” or “unsubstituted” is not added includes a group having a substituent and a group not having a substituent. For example, “alkyl group” includes an alkyl group having a substituent and an alkyl group not having a substituent.

In the present disclosure, a combination of two or more preferred aspects is a more preferred aspect.

<Polymerizable Composition>

The polymerizable composition according to the embodiment of the present disclosure contains a liquid crystal compound represented by Formula (1) and a chiral compound, in which a proportion of a total amount of a compound including one polymerizable group is 60% by mass or more with respect to a total amount of a compound including at least one polymerizable group.

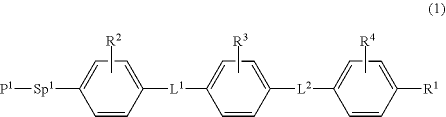

In Formula (1), R¹ to R⁴ each independently represent a hydrogen atom, an alkyl group having 1 to 20 carbon atoms, a group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—, or —CN, where at least one of R², R³, or R⁴ is a substituent which is not a hydrogen atom, L¹ and L² each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, or —C≡C—, Sp¹ represents a single bond, an alkylene group having 1 to 20 carbon atoms, or a group having a structure in which at least one —CH₂— in an alkylene group having 2 to 20 carbon atoms is substituted with —O—, —S—, —NH—, —N(CH₃)—, —C(═O)—, —OC(═O)—, or —C(═O)O—, and P¹ represents a polymerizable group represented by Formula (P-1) or Formula (P-2).

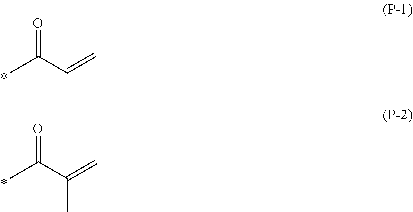

In Formula (P-1) and Formula (P-2), * represents a bonding position.

According to the above-described embodiment, there is provided a polymerizable composition which forms a cured substance with excellent stretchability and reduced defects in a liquid crystal phase. The reason for providing the polymerizable composition as described above in the present disclosure is presumed as follows. In a case where the proportion of the total amount of a monofunctional polymerizable compound (referring to the compound including one polymerizable group; the same applies hereinafter) is 60% by mass or more with respect to the total amount of the polymerizable compound (referring to the compound including at least one polymerizable group; the same applies hereinafter), in composition of the polymerizable compound, the total amount of the monofunctional polymerizable compound is higher than the total amount of a polyfunctional polymerizable compound (referring to a compound including at least two polymerizable groups; the same applies hereinafter). Compared with the polyfunctional polymerizable compound, the monofunctional polymerizable compound forms a polymer having a flexible higher-order structure in a curing process of the polymerizable composition, and stretchability of a cured substance is improved. Furthermore, in a case where a substituent other than a hydrogen atom (that is, “alkyl group having 1 to 20 carbon atoms”, “group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—”, or “—CN”) is introduced into at least one of R², R³, or R⁴, which is bonded to a benzene ring of the liquid crystal compound represented by Formula (1), for example, a liquid crystal phase is expressed in a wide temperature range due to a decrease in crystallization temperature, and solubility of the liquid crystal compound represented by Formula (1) is also improved. As a result, defects in the liquid crystal phase are reduced.

(Component of Polymerizable Composition: Proportion of Monofunctional Polymerizable Compound)

In the polymerizable composition according to the embodiment of the present disclosure, the proportion of the total amount of the monofunctional polymerizable compound (that is, the compound including one polymerizable group) is 60% by mass or more with respect to the total amount of the polymerizable compound (that is, the compound including at least one polymerizable group). As described above, in a case where the proportion of the total amount of the monofunctional polymerizable compound is 60% by mass or more with respect to the total amount of the polymerizable compound, the stretchability of the cured substance is improved.

Examples of the polymerizable compound include a liquid crystal compound including at least one polymerizable group (for example, the liquid crystal compound represented by Formula (1)) and a chiral compound including at least one polymerizable group. However, the type of the polymerizable compound is not limited to the specific examples described above.

Examples of the polymerizable group in the polymerizable compound include an ethylenically unsaturated group and a cyclic ether group. Examples of the ethylenically unsaturated group include an acryloyloxy group, a methacryloyloxy group, an acrylamide group, a methacrylamide group, a vinyl group, a vinyl ester group, and a vinyl ether group. Examples of the cyclic ether group include an epoxy group and an oxetanyl group. However, the type of the polymerizable group is not limited to the specific examples described above. In a case where the polymerizable compound includes at least two polymerizable groups, the types of the plurality of polymerizable groups may be the same or different from each other.

The lower limit and the upper limit of the proportion of the total amount of the monofunctional polymerizable compound with respect to the total amount of the polymerizable compound may be determined according to characteristics of interest. In a case where the proportion of the total amount of the monofunctional polymerizable compound with respect to the total amount of the polymerizable compound is large, the stretchability of the cured substance is improved. The proportion of the total amount of the monofunctional polymerizable compound with respect to the total amount of the polymerizable compound is preferably 65% by mass or more, more preferably 70% by mass or more, and still more preferably 75% by mass or more. Furthermore, the proportion of the total amount of the monofunctional polymerizable compound with respect to the total amount of the polymerizable compound is preferably 80% by mass or more, more preferably 85% by mass or more, and still more preferably 90% by mass or more. On the other hand, in a case where the proportion of the total amount of the monofunctional polymerizable compound with respect to the total amount of the polymerizable compound is small, for example, since the polymerizable composition can be handled even in a high-temperature environment by increasing a lower limit of a temperature range in which an isotropic phase is exhibited, production suitability is improved. The proportion of the total amount of the monofunctional polymerizable compound with respect to the total amount of the polymerizable compound is preferably 95% by mass or less, more preferably 90% by mass or less, and still more preferably 85% by mass or less. From the viewpoint of improving the stretchability of the cured substance and reducing defects in the liquid crystal phase, the proportion of the total amount of the monofunctional polymerizable compound with respect to the total amount of the polymerizable compound is preferably 60% by mass to 95% by mass, more preferably 70% by mass to 90% by mass, and still more preferably 75% by mass to 85% by mass.

(Component of Polymerizable Composition: Liquid Crystal Compound)

The polymerizable composition according to the embodiment of the present disclosure contains a liquid crystal compound represented by Formula (1). As described above, the liquid crystal compound represented by Formula (1) contributes to the reduction of defects in the liquid crystal phase.

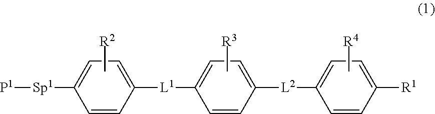

In Formula (1), R¹ to R⁴ each independently represent a hydrogen atom, an alkyl group having 1 to 20 carbon atoms, a group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—, or —CN, where at least one of R², R³, or R⁴ is a substituent which is not a hydrogen atom, L¹ and L² each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, or —C≡C—, Sp¹ represents a single bond, an alkylene group having 1 to 20 carbon atoms, or a group having a structure in which at least one —CH₂— in an alkylene group having 2 to 20 carbon atoms is substituted with —O—, —S—, —NH—, —N(CH₃)—, —C(═O)—, —OC(═O)—, or —C(═O)O—, and P¹ represents a polymerizable group represented by Formula (P-1) or Formula (P-2).

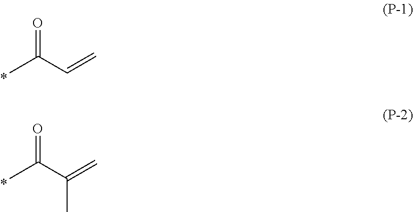

In Formula (P-1) and Formula (P-2), * represents a bonding position.

Hereinafter, in the section of “Liquid crystal compound”, the “group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—” represented by R¹ to R⁴ may be referred to as “specific substituted alkyl group X1”. With regard to the specific substituted alkyl group X1, at least two —CH₂-'s in an alkyl group having 2 to 20 carbon atoms may be each independently substituted with O—, —S—, —NH—, —N(CH₃)—, —C(═O)—, —OC(═O)—, or —C(═O)O—. That is, an atomic group in which —CH₂— is substituted may be the same as or different from another atomic group in which —CH₂— is substituted. A structure of the specific substituted alkyl group X1 may be a structure which does not include two adjacent oxygen atoms (that is, —O—O—).

Hereinafter, in the section of “Liquid crystal compound”, the “group having a structure in which at least one —CH₂— in an alkylene group having 2 to 20 carbon atoms is substituted with —O—, —S—, —NH—, —N(CH₃)—, —C(═O)—, —OC(═O)—, or —C(═O)O—” represented by Sp¹ may be referred to as “specific substituted alkylene group Y1”. With regard to the specific substituted alkylene group Y1, at least two —CH₂-'s in an alkylene group having 2 to 20 carbon atoms may be each independently substituted with O—, —S—, —NH—, —N(CH₃)—, —C(═O)—, —OC(═O)—, or —C(═O)O—. That is, an atomic group in which —CH₂— is substituted may be the same as or different from another atomic group in which —CH₂— is substituted. A structure of the specific substituted alkylene group Y1 may be a structure which does not include two adjacent oxygen atoms (that is, —O—O—).

From the viewpoint of reducing defects in the liquid crystal phase, it is preferable that, in Formula (1), R¹ to R⁴ are each independently a hydrogen atom, an alkyl group having 1 to 20 carbon atoms, or the specific substituted alkyl group X1.

In Formula (1), the alkyl group having 1 to 20 carbon atoms, represented by R¹ to R⁴, (however, excluding the alkyl group having 2 to 20 carbon atoms, which defines the specific substituted alkyl group X1; hereinafter, the same applies in this paragraph) may be a linear, branched, or cyclic alkyl group. From the viewpoint of reducing defects in the liquid crystal phase, the alkyl group is preferably a linear alkyl group or a branched alkyl group. From the viewpoint of improving crystallinity, with regard to the alkyl group having 1 to 20 carbon atoms, represented by R¹, the alkyl group preferably has 1 to 12 carbon atoms, more preferably has 3 to 12 carbon atoms, and still more preferably has 6 to 12 carbon atoms. From the viewpoint of improving crystallinity, with regard to the alkyl group having 1 to 20 carbon atoms, represented by R² to R⁴, the alkyl group preferably has 1 to 10 carbon atoms, more preferably has 1 to 6 carbon atoms, and still more preferably has 1 to 4 carbon atoms. The improvement of the crystallinity contributes to the reduction of defects in the liquid crystal phase. Examples of the alkyl group in the present disclosure include a methyl group (—CH₃), an ethyl group (—C₂H₅), a propyl group (—C₃H₇), and a butyl group (—C₄H₉).

In Formula (1), the alkyl group having 2 to 20 carbon atoms, which defines the specific substituted alkyl group X1, (hereinafter, it may be simply referred to as “alkyl group” in this paragraph) represented by R¹ to R⁴ may be a linear, branched, or cyclic alkyl group. From the viewpoint of reducing defects in the liquid crystal phase, the alkyl group is preferably a linear alkyl group or a branched alkyl group. From the viewpoint of improving crystallinity, with regard to the specific substituted alkyl group X1 represented by R¹, the alkyl group preferably has 2 to 13 carbon atoms, more preferably has 5 to 10 carbon atoms, and still more preferably has 7 to 9 carbon atoms. From the viewpoint of improving crystallinity, with regard to the specific substituted alkyl group X1 represented by R² to R⁴, the alkyl group preferably has 2 to 10 carbon atoms, more preferably has 2 to 6 carbon atoms, and still more preferably has 2 to 4 carbon atoms. The alkyl group is preferably an unsubstituted alkyl group.

From the viewpoint of reducing defects in the liquid crystal phase, in Formula (1), the specific substituted alkyl group X1 represented R¹ to R⁴ is preferably a group having a structure in which at least one —CH₂— in an alkyl group having 2 to 20 carbon atoms is substituted with —O—, —N(CH₃)—, —C(═O)—, —OC(═O)—, or —C(═O)O—. In addition, in Formula (1), the specific substituted alkyl group X1 represented R¹ to R⁴ is also preferably a group having a structure in which at least one —CH₂— in an alkyl group having 2 to 20 carbon atoms is substituted with —O—, —C(═O)—, —OC(═O)—, or —C(═O)O—. In addition, in Formula (1), the specific substituted alkyl group X1 represented R¹ to R⁴ is also preferably a group having a structure in which at least one —CH₂— in an alkyl group having 2 to 20 carbon atoms is substituted with —O—, —OC(═O)—, or —C(═O)O—.

In Formula (1), preferred examples of the specific substituted alkyl group X1 represented by R¹ to R⁴ include an alkoxy group having 1 to 10 carbon atoms, a dialkylamino group having 2 to 12 carbon atoms, an alkylcarbonyl group having 2 to 10 carbon atoms, and an alkoxycarbonyl group having 2 to 10 carbon atoms.

The alkoxy group having 1 to 10 carbon atoms, which is an example of the specific substituted alkyl group X1, is preferably a linear alkoxy group or a branched alkoxy group, and more preferably a linear alkoxy group. The alkoxy group preferably has 2 to 10 carbon atoms, more preferably has 4 to 10 carbon atoms, and still more preferably has 6 to 8 carbon atoms.

Each alkyl group in the dialkylamino group having 2 to 12 carbon atoms, which is an example of the specific substituted alkyl group X1, is preferably a linear alkyl group or a branched alkyl group, and more preferably a linear alkyl group. The dialkylamino group preferably has 2 to 10 carbon atoms, more preferably has 2 to 6 carbon atoms, and still more preferably has 2 to 4 carbon atoms.

An alkyl group in the alkylcarbonyl group having 2 to 10 carbon atoms, which is an example of the specific substituted alkyl group X1, is preferably a linear alkyl group or a branched alkyl group, and more preferably a linear alkyl group. The alkylcarbonyl group preferably has 2 to 10 carbon atoms, more preferably has 2 to 6 carbon atoms, and still more preferably has 2 to 4 carbon atoms.

An alkoxy group in the alkoxycarbonyl group having 2 to 10 carbon atoms, which is an example of the specific substituted alkyl group X1, is preferably a linear alkoxy group or a branched alkoxy group, and more preferably a linear alkoxy group. The alkoxycarbonyl group preferably has 2 to 10 carbon atoms, more preferably has 2 to 6 carbon atoms, and still more preferably has 2 to 4 carbon atoms.

Specific examples of the specific substituted alkyl group X1 represented by R¹ to R⁴ in Formula (1) are shown below. However, the type of the specific substituted alkyl group X1 is not limited to the following specific examples.

(1) specific examples of a group having a structure in which at least one —CH₂— in an alkyl group having 2 to 20 carbon atoms is substituted with —O—; alkoxy group (for example, —OC₆H₁₃ and —OC₈H₁₇)

(2) specific examples of a group having a structure in which at least one —CH₂— in an alkyl group having 2 to 20 carbon atoms is substituted with —N(CH₃)—; dialkylamino group (for example, —N(CH₃)₂)

(3) specific examples of a group having a structure in which at least one —CH₂— in an alkyl group having 2 to 20 carbon atoms is substituted with —C(═O)—; alkylcarbonyl group (for example, —C(═O)CH₃)

(4) specific examples of a group having a structure in which at least one —CH₂— in an alkyl group having 2 to 20 carbon atoms is substituted with —C(═O)O—; alkoxycarbonyl group (for example, —C(═O)OCH₃ and —C(═O)OC₂H₅)

From the viewpoint of reducing defects in the liquid crystal phase, it is preferable that, in Formula (1), R¹ is an alkoxy group having 1 to 10 carbon atoms. A preferred aspect of the alkoxy group having 1 to 10 carbon atoms, represented by R¹, is the same as the preferred aspect of the alkoxy group having 1 to 10 carbon atoms described above.

From the viewpoint of reducing defects in the liquid crystal phase, it is preferable that, in Formula (1), at least one of R² or R³ is an alkyl group having 1 to 10 carbon atoms, an alkoxy group having 1 to 10 carbon atoms, —COOX¹, or —COX², where X¹ and X² each independently represent a linear alkyl group having 1 to 20 carbon atoms or a branched alkyl group having 3 to 20 carbon atoms. In addition, it is preferable that, in Formula (1), at least one of R² or R³ is an alkyl group having 1 to 10 carbon atoms, —COOX¹, or —COX², where X¹ and X² each independently represent a linear alkyl group having 1 to 20 carbon atoms or a branched alkyl group having 3 to 20 carbon atoms. In addition, it is also preferable that, in Formula (1), at least one of R² or R³ is —COOX¹ or —COX², where X¹ and X² each independently represent a linear alkyl group having 1 to 20 carbon atoms or a branched alkyl group having 3 to 20 carbon atoms. The alkoxy group having 1 to 10 carbon atoms, —COOX¹, and —COX² are included in the specific substituted alkyl group X1.

The alkyl group having 1 to 10 carbon atoms, represented by at least one of R² or R³, is preferably a linear alkyl group or a branched alkyl group. The alkyl group preferably has 1 to 6 carbon atoms, and more preferably has 1 to 4 carbon atoms.

The alkoxy group having 1 to 10 carbon atoms, represented by at least one of R² or R³, is preferably a linear alkoxy group or a branched alkoxy group. The alkoxy group preferably has 1 to 6 carbon atoms, and more preferably has 1 to 4 carbon atoms.

With regard to the linear alkyl group having 1 to 20 carbon atoms, represented by X¹ and X², the alkyl group preferably has 1 to 10 carbon atoms, more preferably has 1 to 6 carbon atoms, and still more preferably has 1 to 4 carbon atoms. With regard to the branched alkyl group having 3 to 20 carbon atoms, represented by X¹ and X², the alkyl group preferably has 3 to 10 carbon atoms, and more preferably has 3 to 6 carbon atoms. X¹ and X² are each independently preferably a linear alkyl group having 1 to 20 carbon atoms, more preferably a methyl group or an ethyl group, and still more preferably a methyl group.

From the viewpoint of reducing defects in the liquid crystal phase, it is preferable that, in Formula (1), R³ is —COOX³, where X³ represents a linear alkyl group having 1 to 20 carbon atoms or a branched alkyl group having 3 to 20 carbon atoms. —COOX³ is included in the specific substituted alkyl group X1. A preferred aspect of the linear alkyl group having 1 to 20 carbon atoms, represented by X³, is the same as the preferred aspect of the linear alkyl group having 1 to 20 carbon atoms, represented by X¹ and X², described above. A preferred aspect of the branched alkyl group having 3 to 20 carbon atoms, represented by X³, is the same as the preferred aspect of the branched alkyl group having 3 to 20 carbon atoms, represented by X¹ and X², described above. From the viewpoint of reducing defects in the liquid crystal phase, X³ is preferably a linear alkyl group having 1 to 20 carbon atoms, more preferably a methyl group or an ethyl group, and still more preferably a methyl group.

Preferred combinations of R¹ to R⁴ in Formula (1) are shown below.

R¹: R¹ is preferably the specific substituted alkyl group X1, and more preferably an alkoxy group having 1 to 10 carbon atoms.

R²: R² is preferably a hydrogen atom, an alkyl group having 1 to 20 carbon atoms, or the specific substituted alkyl group X1, and more preferably a hydrogen atom.

R³: R³ is preferably the specific substituted alkyl group X1, more preferably an alkyl group having 1 to 10 carbon atoms, an alkoxy group having 1 to 10 carbon atoms, —COOX¹, or —COX², and still more preferably —COOX³.

R⁴: R⁴ is preferably a hydrogen atom, an alkyl group having 1 to 20 carbon atoms, or the specific substituted alkyl group X1, and more preferably a hydrogen atom.

In Formula (1), it is preferable that R³ is bonded to a carbon atom adjacent to a carbon atom bonded to L¹ in a benzene ring. That is, it is preferable that R³ is located next to (that is, an ortho position of) L¹ in an atomic group bonded to the benzene ring. In a case where R³ is located next to L¹, the crystallization temperature is lowered, and the liquid crystal phase can be expressed in a wide temperature range.

In Formula (1), L¹ and L² each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, or —C≡C—. L¹ and L² are each independently preferably —COO— or —OCO—. In a case where L¹ and L² are each independently —COO— or —OCO—, for example, a temperature range showing a nematic liquid crystal phase is widened. In a case where L¹ and L² are —COO—, for example, the smectic liquid crystal phase is likely to be expressed. In addition, it is also preferable that L¹ is —COO— and L² is —OCO—.

From the viewpoint of reducing defects in the liquid crystal phase, in Formula (1), Sp¹ is preferably an alkylene group having 1 to 20 carbon atoms or the specific substituted alkylene group Y1 (that is, the group having a structure in which at least one —CH₂— in an alkylene group having 2 to 20 carbon atoms is substituted with —O—, —S—, —NH—, —N(CH₃)—, —C(═O)—, —OC(═O)—, or —C(═O)O—), and more preferably the specific substituted alkylene group Y1.

In Formula (1), the alkylene group having 1 to 20 carbon atoms, represented by Sp¹, (however, excluding the alkylene group having 2 to 20 carbon atoms, which defines the specific substituted alkylene group Y1; hereinafter, the same applies in this paragraph) may be a linear, branched, or cyclic alkylene group. From the viewpoint of reducing defects in the liquid crystal phase, the alkylene group is preferably a linear alkylene group or a branched alkylene group, and more preferably a linear alkylene group. From the viewpoint of reducing defects in the liquid crystal phase, the alkylene group preferably has 1 to 10 carbon atoms, more preferably has 2 to 8 carbon atoms, and still more preferably 4 to 6 carbon atoms. Examples of the alkylene group in the present disclosure include a methylene group (—CH₂—), an ethylene group (—C₂H₄—), a propylene group (—C₃H₆—), a butylene group (—C₄H₈—), and a hexylene group (—C₆H₁₂—).

In Formula (1), the alkylene group having 2 to 20 carbon atoms, which defines the specific substituted alkylene group Y1, (hereinafter, it may be simply referred to as “alkylene group” in this paragraph) represented by Sp¹ may be a linear, branched, or cyclic alkylene group. From the viewpoint of reducing defects in the liquid crystal phase, the alkylene group is preferably a linear alkylene group or a branched alkylene group, and more preferably a linear alkylene group. From the viewpoint of reducing defects in the liquid crystal phase, the alkylene group preferably has 2 to 10 carbon atoms, more preferably has 2 to 8 carbon atoms, and still more preferably has 4 to 6 carbon atoms. The alkylene group is preferably an unsubstituted alkylene group.

From the viewpoint of reducing defects in the liquid crystal phase, in Formula (1), the specific substituted alkylene group Y1 represented by Sp¹ is preferably a group having a structure in which at least one —CH₂— in an alkylene group having 2 to 20 carbon atoms is substituted with —O—, and more preferably a group having a structure in which at least two —CH₂-'s in an alkylene group having 2 to 20 carbon atoms is substituted with —O—.

From the viewpoint of reducing defects in the liquid crystal phase, in Formula (1), the specific substituted alkylene group Y1 represented by Sp¹ is an alkylenedioxy group having 1 to 18 carbon atoms. The alkylenedioxy group may be a linear or branched alkylenedioxy group. The alkylenedioxy group is preferably a linear alkylenedioxy group. The alkylenedioxy group preferably has 2 to 10 carbon atoms, more preferably 4 to 8 carbon atoms, and particularly preferably 4 to 6 carbon atoms. Examples of the alkylenedioxy group include —O—C₂H₂—O—, —O—C₃H₆—O—, —O—C₄H₈—O—, —O—C₅H₁₀—O—, and —O—C₆H₁₂—O—.

From the viewpoint of improving crystallinity, in Formula (1), P¹ is preferably the polymerizable group represented by Formula (P-1).

Examples of the liquid crystal compound represented by Formula (1) include a liquid crystal compound represented by Formula (1-1). From the viewpoint of reducing defects in the liquid crystal phase, the liquid crystal compound represented by Formula (1) is preferably a liquid crystal compound represented by Formula (1-1).

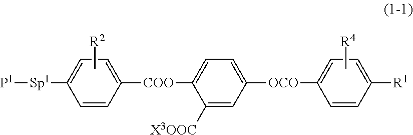

In Formula (1-1), R¹ has the same meaning as R¹ in Formula (1), R² has the same meaning as R² in Formula (1), R⁴ has the same meaning as R⁴ in Formula (1), Sp¹ has the same meaning as Sp¹ in Formula (1), P¹ has the same meaning as P¹ in Formula (1), and X³ represents a linear alkyl group having 1 to 20 carbon atoms or a branched alkyl group having 3 to 20 carbon atoms. X³ in Formula (1-1) has the same meaning as X³ in Formula (1).

Specific examples of the liquid crystal compound represented by Formula (1) are shown below. However, the type of the liquid crystal compound represented by Formula (1) is not limited to the following specific examples. In the following specific examples, Me represents a methyl group, Et represents an ethyl group, iPr represents an isopropyl group, and tBu represents a tert-butyl group.

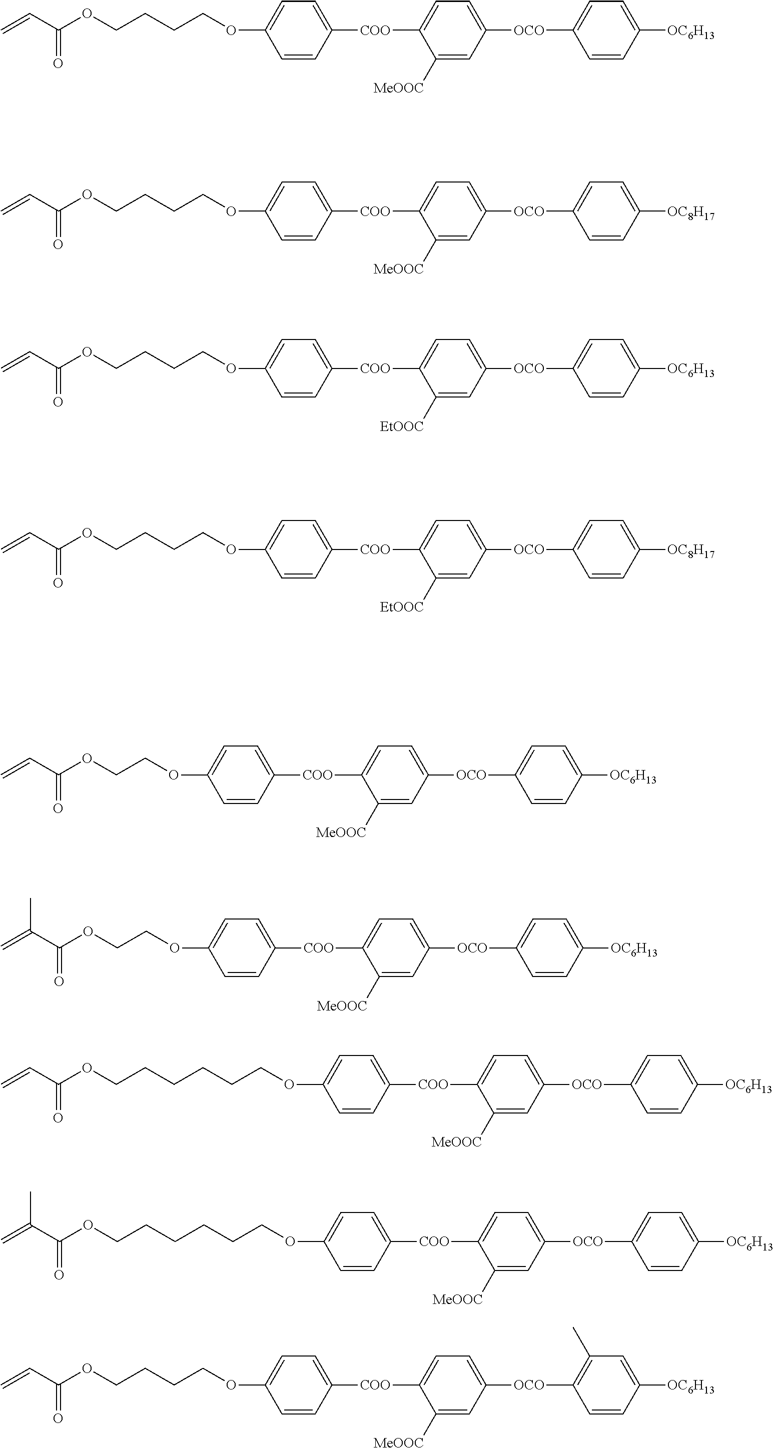

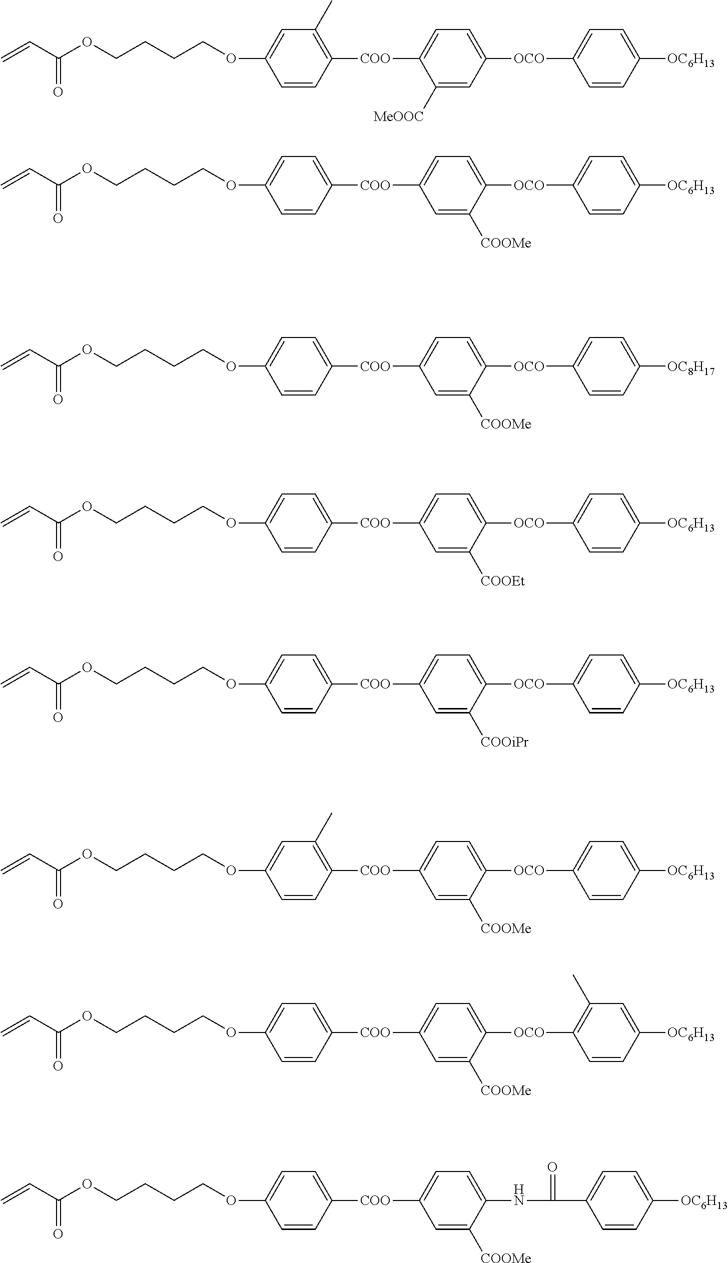

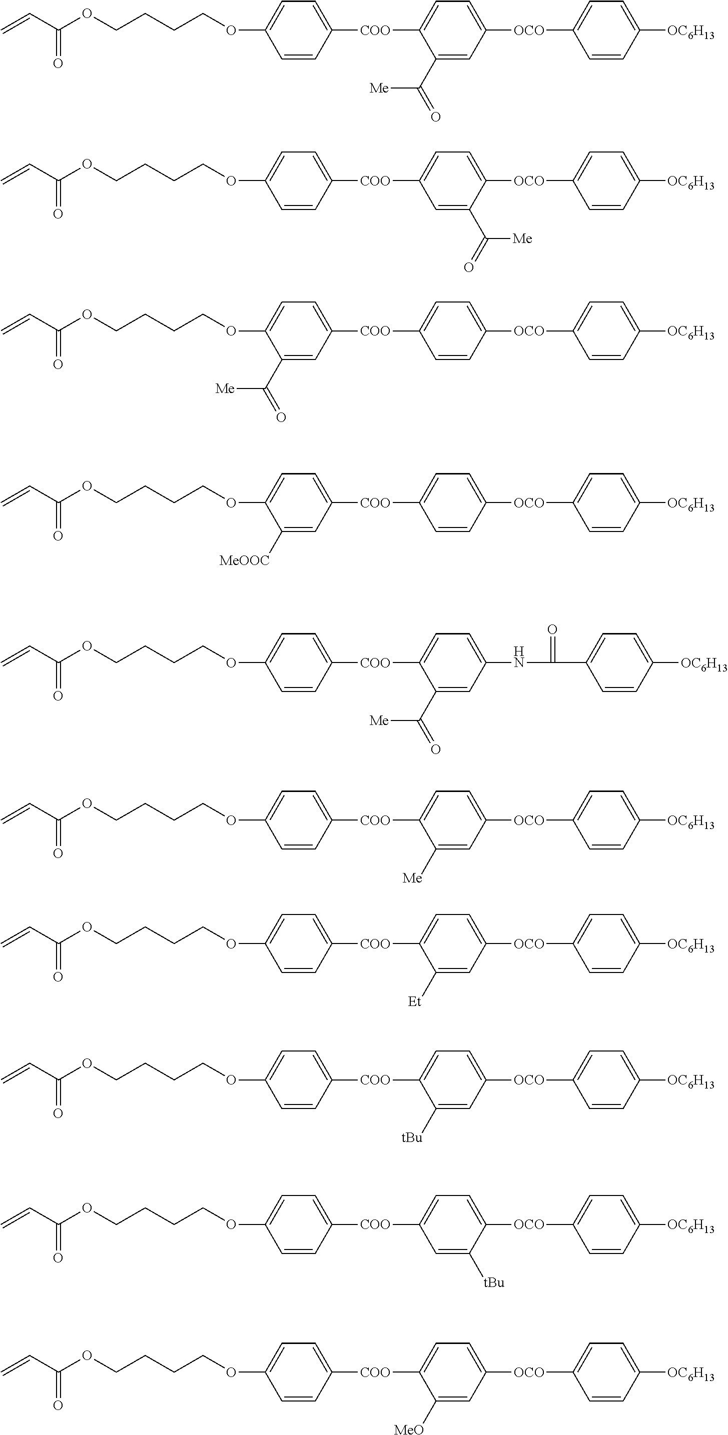

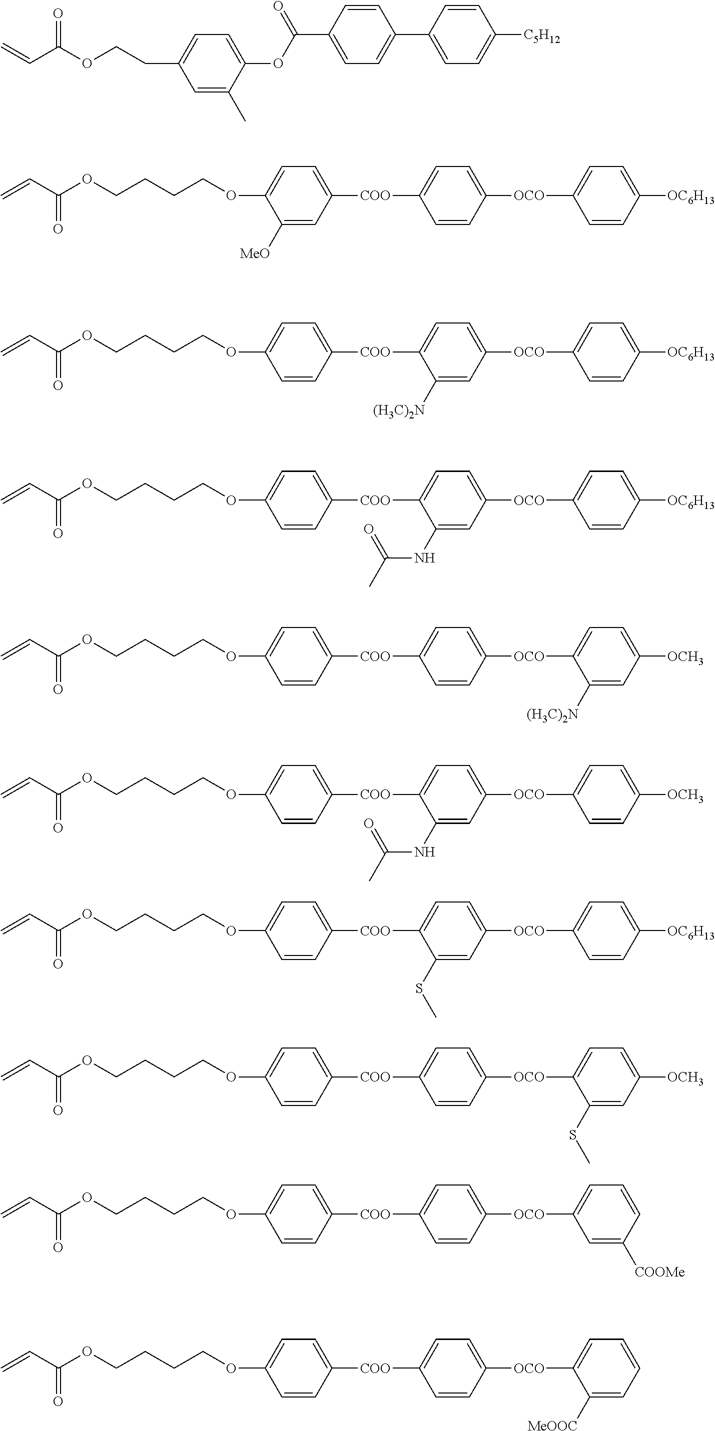

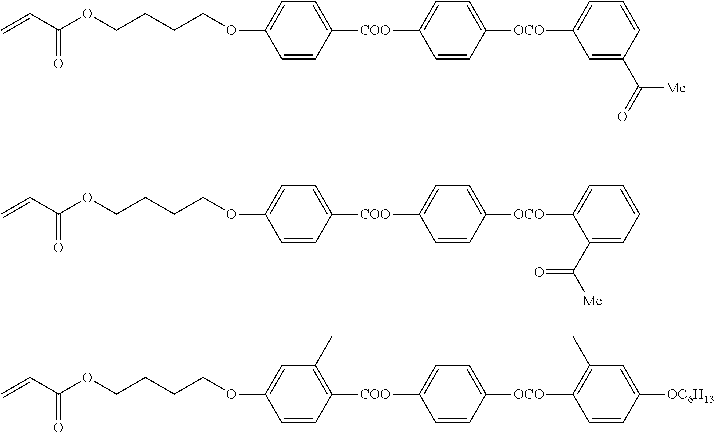

The polymerizable composition according to the embodiment of the present disclosure may contain one or two or more kinds of the liquid crystal compounds represented by Formula (1).

From the viewpoint of improving the stretchability of the cured substance and reducing defects in the liquid crystal phase, a proportion of the total amount of the liquid crystal compound represented by Formula (1) is preferably 5% by mass to 99% by mass, more preferably 25% by mass to 98% by mass, and still more preferably 75% by mass to 98% by mass with respect to the total amount of solid contents of the polymerizable composition.

The polymerizable composition according to the embodiment of the present disclosure may further contain other liquid crystal compounds as necessary. The “other liquid crystal compounds” means a liquid crystal compound other than the liquid crystal compound represented by Formula (1).

Examples of the other liquid crystal compounds include a liquid crystal compound including at least one polymerizable group. Examples of the liquid crystal compound including at least one polymerizable group include a liquid crystal compound including at least one selected from the group consisting of an ethylenically unsaturated group and a cyclic ether group. Examples of the ethylenically unsaturated group include a (meth)acryloyloxy group, a (meth)acrylamide group, a vinyl group, a vinyl ester group, and a vinyl ether group. In the present disclosure, the term “(meth)acryloyloxy group” includes an acryloyloxy group (that is, CH₂═CH—COO—) and a methacryloyloxy group (that is, CH₂═CH(CH₃)—COO—). In the present disclosure, the term “(meth)acrylamide group” includes an acrylamide group and a methacrylamide group. As the ethylenically unsaturated group, from the viewpoint of reactivity, a (meth)acryloyloxy group, a (meth)acrylamide group, or an aromatic vinyl group is preferable, a (meth)acryloyloxy group or a (meth)acrylamide group is more preferable, and a (meth)acryloyloxy group is still more preferable. As the cyclic ether group, from the viewpoint of reactivity, an epoxy group or an oxetanyl group is preferable, and an oxetanyl group is more preferable.

The other liquid crystal compounds may be a rod-like liquid crystal compound or a disk-like liquid crystal compound. Examples of the rod-like liquid crystal compound include azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles. For example, the rod-like liquid crystal compound may be selected from compounds described in “Makromol. Chem., vol. 190, p. 2255 (1989), Advanced Materials, vol. 5, p. 107 (1993)”, U.S. Pat. No. 4,683,327A, 5,622,648A, 5,770,107A, WO1995/022586A, WO1995/024455A, WO1997/000600A, WO1998/023580A, WO1998/052905A, JP1989-272551A (JP-H1-272551A), JP1994-16616A (JP-H6-16616A), JP1995-110469A (JP-H7-110469A), JP1999-80081A (JP-H11-80081A), JP2001-328973A, JP1999-513019B (JP-H11-513019B), and JP2007-279688A. For example, the disk-like liquid crystal compound may be selected from compounds described in JP2007-108732A and JP2010-244038A. Each of the above-mentioned documents is incorporated herein by reference.

For example, the other liquid crystal compounds may also be selected from compounds described in WO2017/199812A, JP2002-338668A, WO2018/146995A, and WO2020/049957A. Each of the above-mentioned documents is incorporated herein by reference.

Examples of the other liquid crystal compounds include LC—1 described in Examples later. Specific examples of the other liquid crystal compounds are shown below. However, the types of the other liquid crystal compounds are not limited to the following specific examples.

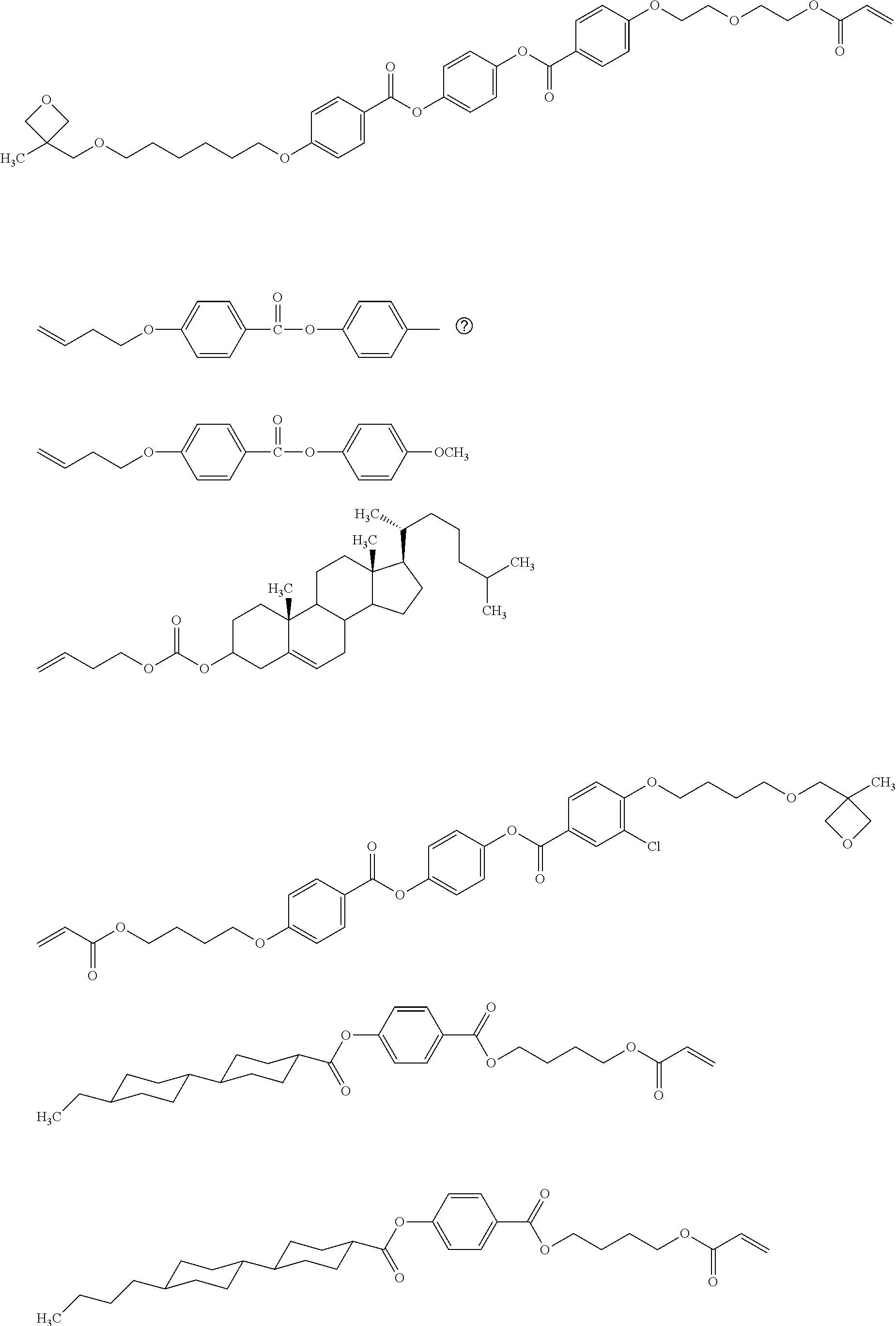

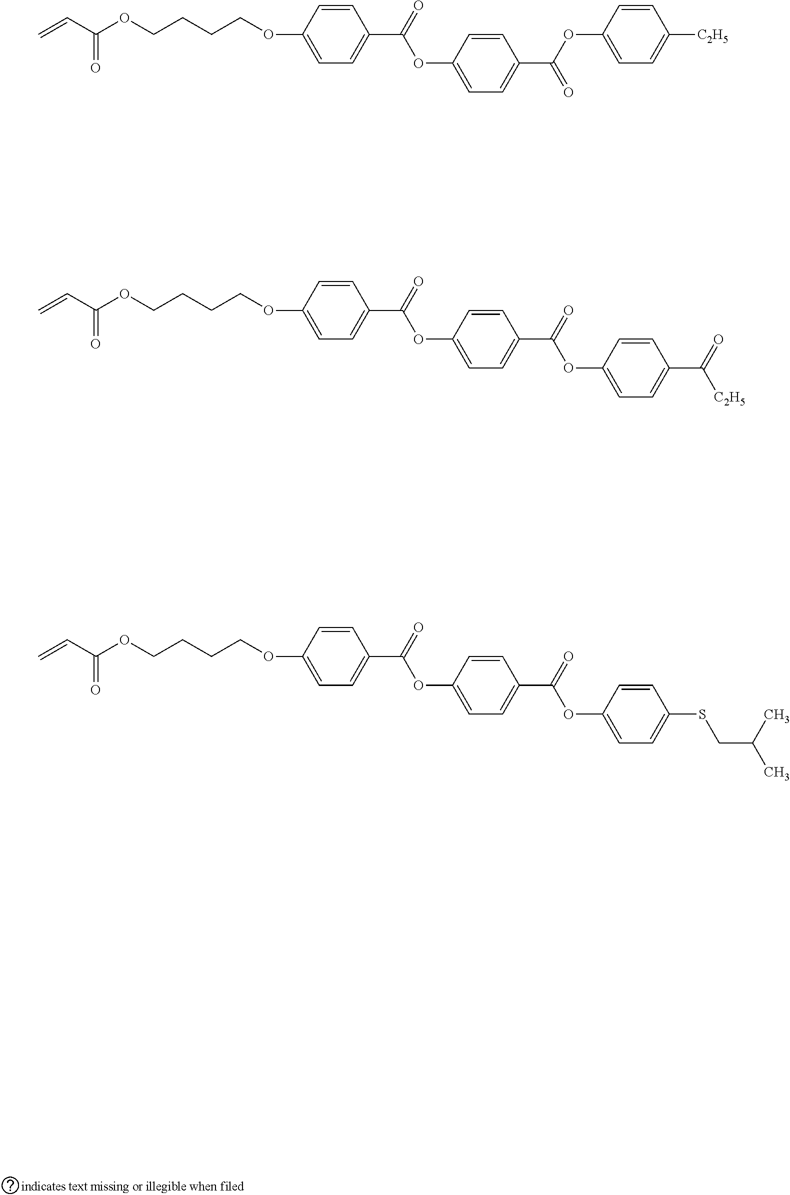 [SMILES: C=CC(=O)OCCCCOc1ccc(C(=O)Oc2ccc(C(=O)Oc3ccc(CC)cc3)cc2)cc1 ; C=CC(=O)OCCCCOc1ccc(C(=O)Oc2ccc(C(=O)Oc3ccc(C(=O)CC)cc3)cc2)cc1 ; C=CC(=O)OCCCCOc1ccc(C(=O)Oc2ccc(C(=O)Oc3ccc(SCC(C)C)cc3)cc2)cc1]

The polymerizable composition according to the embodiment of the present disclosure may contain one or two or more kinds of the other liquid crystal compounds.

From the viewpoint of expression of the liquid crystal phase, a proportion of the total amount of the liquid crystal compound is preferably 5% by mass to 99% by mass, more preferably 25% by mass to 98% by mass, and still more preferably 75% by mass to 98% by mass with respect to the total amount of solid contents of the polymerizable composition. In the present disclosure, the “total amount of the liquid crystal compound” means the total amount of the liquid crystal compound represented by Formula (1) and the other liquid crystal compounds. However, the term “total amount of the liquid crystal compound” does not necessarily mean that the polymerizable composition includes both the liquid crystal compound represented by Formula (1) and the other liquid crystal compounds. For example, in a case where the polymerizable composition contains only the liquid crystal compound represented by Formula (1) as the liquid crystal compound, the “total amount of the liquid crystal compound” corresponds to the total amount of the liquid crystal compound represented by Formula (1).

From the viewpoint of improving the stretchability of the cured substance and reducing defects in the liquid crystal phase, the proportion of the total amount of a monofunctional liquid crystal compound (that is, a liquid crystal compound including one polymerizable group) with respect to the total amount of the liquid crystal compound is preferably 61% by mass to 100% by mass, more preferably 70% by mass to 96% by mass, and still more preferably 80% by mass to 92% by mass.

(Component of Polymerizable Composition: Chiral Compound)

The polymerizable composition according to the embodiment of the present disclosure contains a chiral compound. The chiral compound can control an alignment of the liquid crystal compound. The chiral compound can, for example, induce a helical structure in the cholesteric liquid crystalline phase.

Examples of the chiral compound include compounds described in “chiral agent for twisted nematic (TN) and super-twisted nematic (STN), compound described in “Liquid Crystal Device Handbook”, Chapter 3, Section 4-3, p. 199, Japan Society for the Promotion of Science edited by the 142nd committee, 1989”. Examples of the chiral compound also include an isosorbide and an isomannide derivative. Examples of the chiral compound also include an axially chiral compound and a planar chiral compound. Examples of the axially chiral compound and the planar chiral compound include a binaphthyl compound, a helicene compound, and a paracyclophane compound.

The chiral compound may have a property that a chemical structure changes by action of light. A chiral compound having the above-described property can change, for example, a reflection wavelength in the liquid crystal phase. Examples of the light include ultraviolet light, visible light, and infrared light. Examples of a reaction which causes the change in chemical structure by action of light include a photoisomerization reaction, a photodimerization reaction, and a photodecomposition reaction. Examples of the photoisomerization reaction include isomerization starting from a double bond introduced into the molecule (for example, cis-trans isomerization). Examples of an atomic group causing the photoisomerization reaction include —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, and —N═N—. Examples of the compound which causes a photoisomerization reaction include an azobenzene compound and a spiropyran compound. In the photodimerization reaction, for example, a cyclization addition reaction occurs by action of light. Examples of the compound which causes a photodimerization reaction include a cinnamic acid derivative, a coumarin derivative, a chalcone derivative, and a benzophenone derivative.

The chiral compound preferably includes a chiral compound including at least one polymerizable group. The chiral compound including at least one polymerizable group improves durability of the cured substance. Examples of the polymerizable group include the ethylenically unsaturated group and cyclic ether group described above. The polymerizable group is preferably an ethylenically unsaturated group, more preferably a (meth)acryloyloxy group, and still more preferably an acryloyloxy group (that is, CH₂═CH—COO—). From the viewpoint of improving the durability of the cured substance, the chiral compound is preferably a chiral compound including at least two polymerizable groups. In a case where the chiral compound includes at least two polymerizable groups, the types of the plurality of polymerizable groups may be the same or different from each other.

The chiral compound preferably includes a chiral compound represented by Formula (2). The chiral compound represented by Formula (2) is a chiral compound including a polymerizable group.

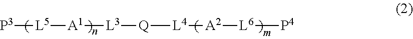

In Formula (2), L³ to L⁶ each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, —C≡C—, or —N═N—, A¹ and A² each independently represent a hydrocarbon ring group or a hetero ring group, P³ and P⁴ each independently represent a hydrogen atom, an alkyl group having 1 to 20 carbon atoms, a group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—, —CN, or -Sp²-P⁵, where Sp² represents a single bond, an alkylene group having 1 to 20 carbon atoms, or a group in which at least one —CH₂— in an alkylene group having 2 to 20 carbon atoms is substituted with —O—, —S—, —NH—, —N(CH₃)—, —C(═O)—, —OC(═O)—, or —C(═O)O—, P⁵ represents a polymerizable group represented by Formula (P-3) or Formula (P-4), and at least one of P³ or P⁴ is -Sp²-P⁵, Q represents a divalent chiral source, and n and m each independently represent an integer of 1 to 3, where, in a case where n or m is an integer of 2 or more, a plurality of A¹'s may be the same or different from each other, a plurality of A²'s may be the same or different from each other, a plurality of L⁵'s may be the same or different from each other, and a plurality of L⁶'s may be the same or different from each other.

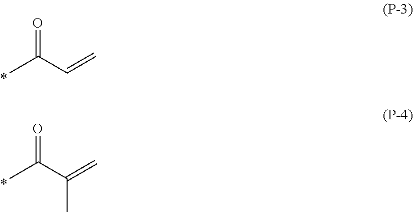

In Formula (P-3) and Formula (P-4), * represents a bonding position.

Hereinafter, in the section of “Chiral compound”, the “group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—” represented by P³ and P⁴ may be referred to as “specific substituted alkyl group X2”. With regard to the specific substituted alkyl group X2, at least two —CH₂-'s in an alkyl group having 2 to 20 carbon atoms may be each independently substituted with O—, —S—, —NH—, —N(CH₃)—, —C(═O)—, —OC(═O)—, or —C(═O)O—. That is, an atomic group in which —CH₂— is substituted may be the same as or different from another atomic group in which —CH₂— is substituted. A structure of the specific substituted alkyl group X2 may be a structure which does not include two adjacent oxygen atoms (that is, —O—O—).

Hereinafter, in the section of “Chiral compound”, the “group in which at least one —CH₂— in an alkylene group having 2 to 20 carbon atoms is substituted with —O—, —S—, —NH—, —N(CH₃)—, —C(═O)—, —OC(═O)—, or —C(═O)O—” represented by Sp² may be referred to as “specific substituted alkylene group Y2”. With regard to the specific substituted alkylene group Y2, at least two —CH₂-'s in an alkylene group having 2 to 20 carbon atoms may be each independently substituted with O—, —S—, —NH—, —N(CH₃)—, —C(═O)—, —OC(═O)—, or —C(═O)O—. That is, an atomic group in which —CH₂— is substituted may be the same as or different from another atomic group in which —CH₂— is substituted. A structure of the specific substituted alkylene group Y2 may be a structure which does not include two adjacent oxygen atoms (that is, —O—O—).

From the viewpoint of improving reflection wavelength conversion ability, it is preferable that, in Formula (2), at least one of L³, . . . , or L⁶ is —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, or —N═N—. In addition, it is also preferable that, in Formula (2), at least one of L³, or L⁶ is —CH═CH—COO—, —OCO—CH═CH—, —CH═C(CN)—COO—, or —OCO—C(CN)═CH—. In addition, it is also preferable that, in Formula (2), at least one of L³, . . . , or L⁶ is —CH═C(CN)—COO— or —OCO—C(CN)═CH—. The “reflection wavelength conversion ability” means a property that the reflection wavelength changes due to an intentional external factor, as will be described in Examples later.

From the viewpoint of improving reflection wavelength conversion ability, it is preferable that, in Formula (2), at least one of L³ or L⁴ is —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, or —N═N—. In addition, it is also preferable that, in Formula (2), at least one of L³ or L⁴ is —CH═CH—COO—, —OCO—CH═CH—, —CH═C(CN)—COO—, or —OCO—C(CN)═CH—. In addition, it is also preferable that, in Formula (2), at least one of L³ or L⁴ is —CH═C(CN)—COO— or —OCO—C(CN)═CH—.

From the viewpoint of improving reflection wavelength conversion ability, it is preferable that, in Formula (2), L³ and L⁴ are each independently —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, or —N═N—. In addition, it is also preferable that, in Formula (2), L³ and L⁴ are each independently —CH═CH—COO—, —OCO—CH═CH—, —CH═C(CN)—COO—, or —OCO—C(CN)═CH—. In addition, it is also preferable that, in Formula (2), L³ and L⁴ are each independently —CH═C(CN)—COO— or —OCO—C(CN)═CH—.

From the viewpoint of ease of synthesis, it is preferable that, in Formula (2), at least one of L⁵ or L⁶ is a single bond, —COO—, —OCO—, or —O—. In addition, it is also preferable that, in Formula (2), L⁵ and L⁶ are each independently a single bond, —COO—, —OCO—, or —O—.

The hydrocarbon ring group includes at least one hydrocarbon ring. The hydrocarbon ring may be a fused ring. The number of atoms constituting the hydrocarbon ring is preferably 5 to 18, more preferably 5 to 10, and still more preferably 5 or 6. Examples of the hydrocarbon ring group include an aliphatic hydrocarbon ring group and an aromatic hydrocarbon ring group.

The aliphatic hydrocarbon ring group includes at least one aliphatic hydrocarbon ring. In a case where the aliphatic hydrocarbon ring has a polycyclic structure, it is preferable that at least one of rings included in the polycyclic structure is a 5- or higher membered ring. The number of atoms constituting the aliphatic hydrocarbon ring is preferably 5 to 10, and more preferably 5 or 6. Examples of the aliphatic hydrocarbon ring include a cyclopentane ring, a cyclohexane ring, a cycloheptane ring, a cyclooctane ring, a norbornene ring, and an adamantane ring. A cyclopentane ring or a cyclohexane ring is preferable.

The aromatic hydrocarbon ring group includes at least one aromatic hydrocarbon ring. In a case where the aromatic hydrocarbon ring has a polycyclic structure, it is preferable that at least one of rings included in the polycyclic structure is a 5- or higher membered ring. The number of atoms constituting the aromatic hydrocarbon ring is preferably 6 to 18, more preferably 6 to 10, and still more preferably 6. Examples of the aromatic hydrocarbon ring include a benzene ring, a naphthalene ring, an anthracene ring, a phenanthrene ring, and a fluorene ring. A benzene ring or a naphthalene ring is preferable, and a benzene ring is more preferable.

Specific examples of the hydrocarbon ring are shown below. However, the type of the hydrocarbon ring is not limited to the following specific examples.

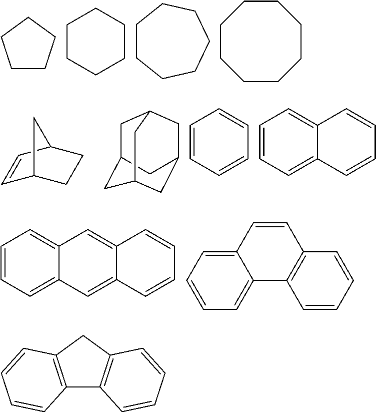

In Formula (2), the hydrocarbon ring group represented by A¹ and A² may have a substituent. Examples of the substituent include an alkyl group, an alkoxy group, an amino group, a nitro group, a hydroxy group, a carboxy group, and a halogen atom. Examples of the substituent also include the specific substituted alkyl group X1 described in the section of “Liquid crystal compound” above. The hydrocarbon ring group is preferably an unsubstituted hydrocarbon ring group.

The hetero ring group includes at least one hetero ring. The hetero ring may be a fused ring. The number of atoms constituting the hetero ring is preferably 5 to 18. Examples of a heteroatom included in the hetero ring include a nitrogen atom, an oxygen atom, and a sulfur atom. Examples of the hetero ring group include an aliphatic hetero ring group and an aromatic heterocyclic group.

The aliphatic hetero ring group includes at least one aliphatic hetero ring. In a case where the aliphatic hetero ring has a polycyclic structure, it is preferable that at least one of rings included in the polycyclic structure is a 5- or higher membered ring. The number of atoms constituting the aliphatic hetero ring is preferably 5 to 10. Examples of the aliphatic hetero ring include an oxolane ring, an oxane ring, a piperidine ring, and a piperazine ring. The aliphatic hetero ring may have a ring structure including —CO—. Examples of the aliphatic hetero ring having a ring structure including —CO— include a phthalimide ring.

The aromatic heterocyclic group includes at least one aromatic heterocyclic ring. In a case where the aromatic heterocyclic ring has a polycyclic structure, it is preferable that at least one of rings included in the polycyclic structure is a 5- or higher membered ring. The number of atoms constituting the aromatic heterocyclic ring is preferably 5 to 18. Examples of the aromatic heterocyclic ring include a pyridine ring, a pyridazine ring, a pyrimidine ring, a pyrazine ring, a triazine ring, a thiophene ring, a thiazole ring, and an imidazole ring.

Specific examples of the hetero ring are shown below. However, the type of the hetero ring is not limited to the following specific examples.

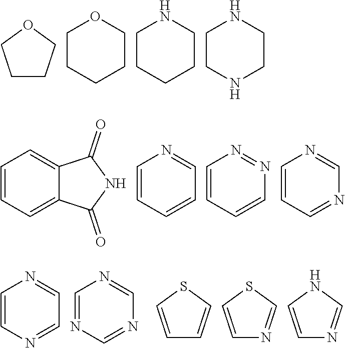

In Formula (2), the hetero ring group represented by A¹ and A² may have a substituent. Examples of the substituent include the substituents of the hydrocarbon ring group described above. The hetero ring group is preferably an unsubstituted hetero ring group.

In Formula (2), the alkyl group having 1 to 20 carbon atoms, represented by P³ and P⁴, (however, excluding the alkyl group having 2 to 20 carbon atoms, which defines the specific substituted alkyl group X2) may be a linear, branched, or cyclic alkyl group.

In Formula (2), the alkyl group having 2 to 20 carbon atoms, which defines the specific substituted alkyl group X2, represented by P³ and P⁴ may be a linear, branched, or cyclic alkyl group.

In Formula (2), the alkylene group having 1 to 20 carbon atoms, represented by Sp², (however, excluding the alkylene group having 2 to 20 carbon atoms, which defines the specific substituted alkylene group Y2) may be a linear, branched, or cyclic alkylene group.

In Formula (2), the alkylene group having 2 to 20 carbon atoms, which defines the specific substituted alkylene group Y2, (hereinafter, it may be simply referred to as “alkylene group” in this paragraph) represented by Sp² may be a linear, branched, or cyclic alkylene group. From the viewpoint of reduction of defects in the liquid crystal phase and ease of acquisition, the alkylene group is preferably a linear alkylene group or a branched alkylene group, and more preferably a linear alkylene group. From the viewpoint of reduction of defects in the liquid crystal phase and ease of acquisition, the alkylene group preferably has 2 to 10 carbon atoms, more preferably has 2 to 8 carbon atoms, and still more preferably has 4 to 6 carbon atoms. The alkylene group is preferably an unsubstituted alkylene group. It is presumed that the reason why the defects in the liquid crystal phase are reduced by each of the above-described aspects is that mobility of the chiral compound represented by Formula (2) is increased and aligning properties of the liquid crystal is not impaired.

From the viewpoint of reduction of defects in the liquid crystal phase and ease of acquisition, it is preferable that, in Formula (2), the specific substituted alkylene group Y2 represented by Sp² is a group having a structure in which at least one —CH₂— in an alkylene group having 2 to 20 carbon atoms is substituted with —O—. In addition, it is also preferable that, in Formula (2), the specific substituted alkylene group Y2 represented by Sp² is a group having a structure in which at least two —CH₂-'s in an alkylene group having 2 to 20 carbon atoms is substituted with —O—.

From the viewpoint of reduction of defects in the liquid crystal phase and ease of acquisition, it is preferable that, in Formula (2), the specific substituted alkylene group Y2 represented by Sp² is an alkyleneoxy group having 1 to 19 carbon atoms or an alkylenedioxy group having 1 to 18 carbon atoms. In addition, it is also preferable that, in Formula (2), the specific substituted alkylene group Y2 represented by Sp² is an alkyleneoxy group having 1 to 19 carbon atoms. In addition, it is also preferable that, in Formula (2), the specific substituted alkylene group Y2 represented by Sp² is an alkylenedioxy group having 1 to 18 carbon atoms.

The alkyleneoxy group having 1 to 19 carbon atoms may be a linear or branched alkyleneoxy group. The alkyleneoxy group is preferably a linear alkyleneoxy group. The alkyleneoxy group preferably has 2 to 10 carbon atoms, more preferably 4 to 8 carbon atoms, and particularly preferably 4 to 6 carbon atoms. Examples of the alkyleneoxy group include —OC₂H₂—, —OC₃H₆—, —OC₄H₈—, —OC₅H₁₀—, and —OC₆H₁₂—.

The alkylenedioxy group having 1 to 18 carbon atoms may be a linear or branched alkylenedioxy group. The alkylenedioxy group is preferably a linear alkylenedioxy group. The alkylenedioxy group preferably has 2 to 10 carbon atoms, more preferably 4 to 8 carbon atoms, and particularly preferably 4 to 6 carbon atoms. Examples of the alkylenedioxy group include the alkylenedioxy group described in the section of “Liquid crystal compound” above.

From the viewpoint of reactivity and ease of acquisition, in Formula (2), P⁵ is preferably the polymerizable group represented by Formula (P-3).

From the viewpoint of improving the durability of the cured substance, it is preferable that, in Formula (2), P³ and P⁴ are each independently -Sp²-P⁵.

In Formula (2), the divalent chiral source represented by Q contributes to expression of chirality. A chemical structure of the divalent chiral source is not limited as long as the divalent chiral source contributes to the expression of chirality. Specific examples of the divalent chiral source are shown below. However, the type of the divalent chiral source is not limited to the following specific examples.

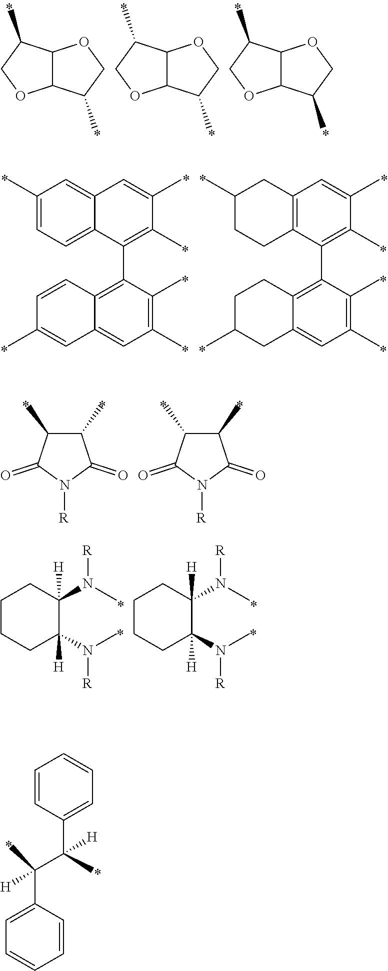

In the above-described specific examples, * represents a bonding position and R represents a substituent. In the above-described specific examples, a binaphthyl skeleton may be an (R)-form or an (S)-form. In the above-described specific examples, the binaphthyl skeleton may be a mixture of the (R)-form and the (S)-form.

It is preferable that, in Formula (2), Q is a divalent chiral source including a binaphthyl skeleton, an isosorbide skeleton, or an isomannide skeleton. Furthermore, it is preferable that, in Formula (2), Q is a divalent chiral source represented by Formula (Q-1) or Formula (Q-2), and it is more preferable to be a divalent chiral source represented by Formula (Q-1).

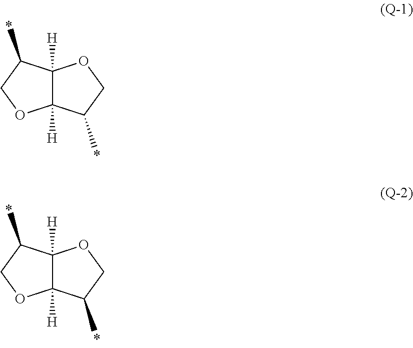

In Formula (Q-1) and Formula (Q-2), * represents a bonding position.

From the viewpoint of improving reflection wavelength conversion ability, in Formula (2), n and m are each independently preferably 2 or 3, and more preferably 2.

Examples of the chiral compound represented by Formula (2) include a chiral compound represented by Formula (2-1) or Formula (2-2). The chiral compound represented by Formula (2) is preferably a chiral compound represented by Formula (2-1) or Formula (2-2).

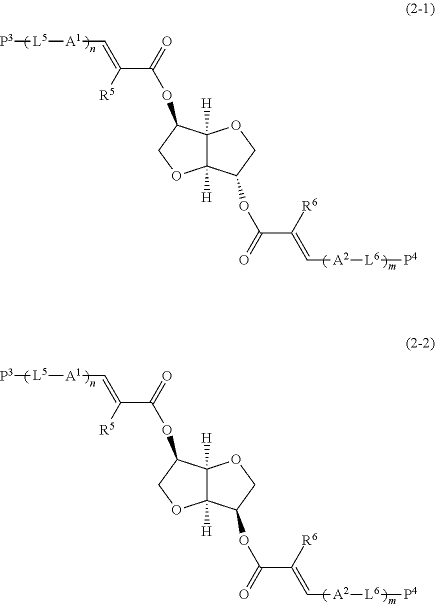

In Formula (2-1) and Formula (2-2), L⁵ has the same meaning as L⁵ in Formula (2), L⁶ has the same meaning as L⁶ in Formula (2), A¹ has the same meaning as A¹ in Formula (2), A² has the same meaning as A² in Formula (2), P³ has the same meaning as P³ in Formula (2), P⁴ has the same meaning as P⁴ in Formula (2), n has the same meaning as n in Formula (2), m has the same meaning as m in Formula (2), and R⁵ and R⁶ each independently represent a hydrogen atom, —CN, or an alkyl group having 1 to 10 carbon atoms.

In Formula (2-1) and Formula (2-2), the alkyl group having 1 to 10 carbon atoms, represented by R⁵ and R⁶, may be a linear, branched, or cyclic alkyl group. From the viewpoint of expression of large helical inducing force, the alkyl group is preferably a linear alkyl group or a branched alkyl group, and more preferably a linear alkyl group. From the viewpoint of expression of large helical inducing force, the alkyl group preferably has 1 to 3 carbon atoms, and more preferably 1 carbon atom. In addition, due to the expression of large helical inducing force, it is also expected to reduce defects in the liquid crystal phase and improve the reflection wavelength conversion ability.

From the viewpoint of improving reflection wavelength conversion ability, it is preferable that, in Formula (2-1) and Formula (2-2), at least one of R⁵ or R⁶ is —CN. In addition, it is also preferable that, in Formula (2-1) or Formula (2-2), R⁵ and R⁶ are —CN.

Specific examples of the chiral compound represented by Formula (2) are shown below. However, the type of the chiral compound represented by Formula (2) is not limited to the following specific examples.

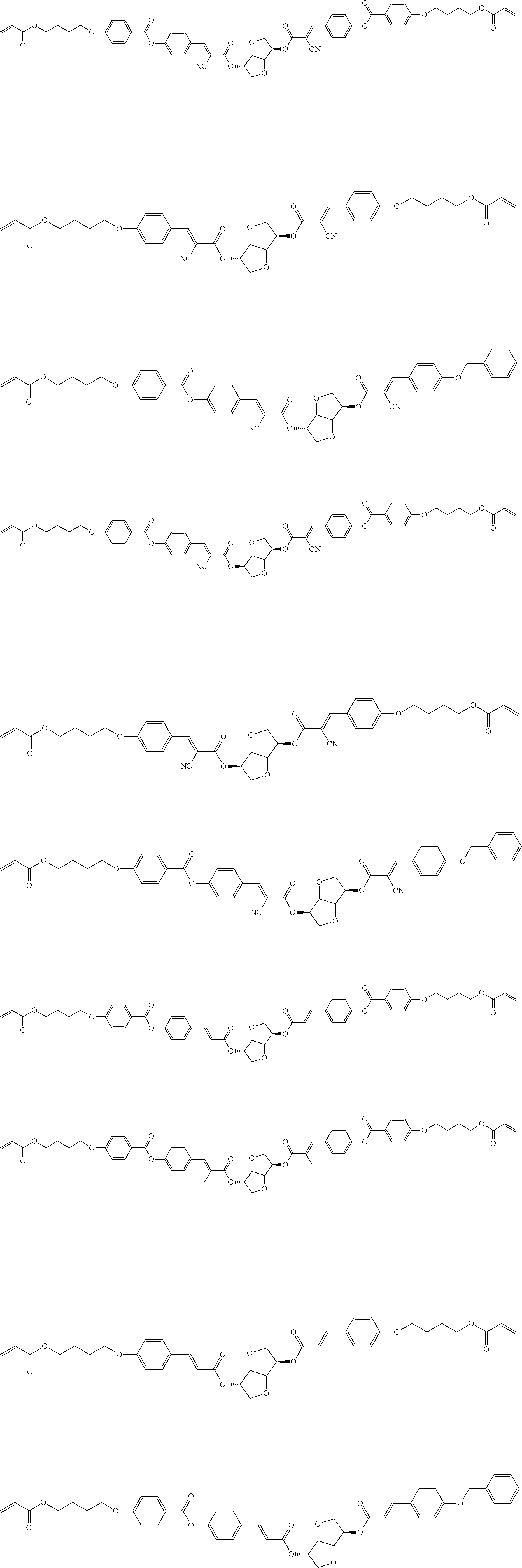

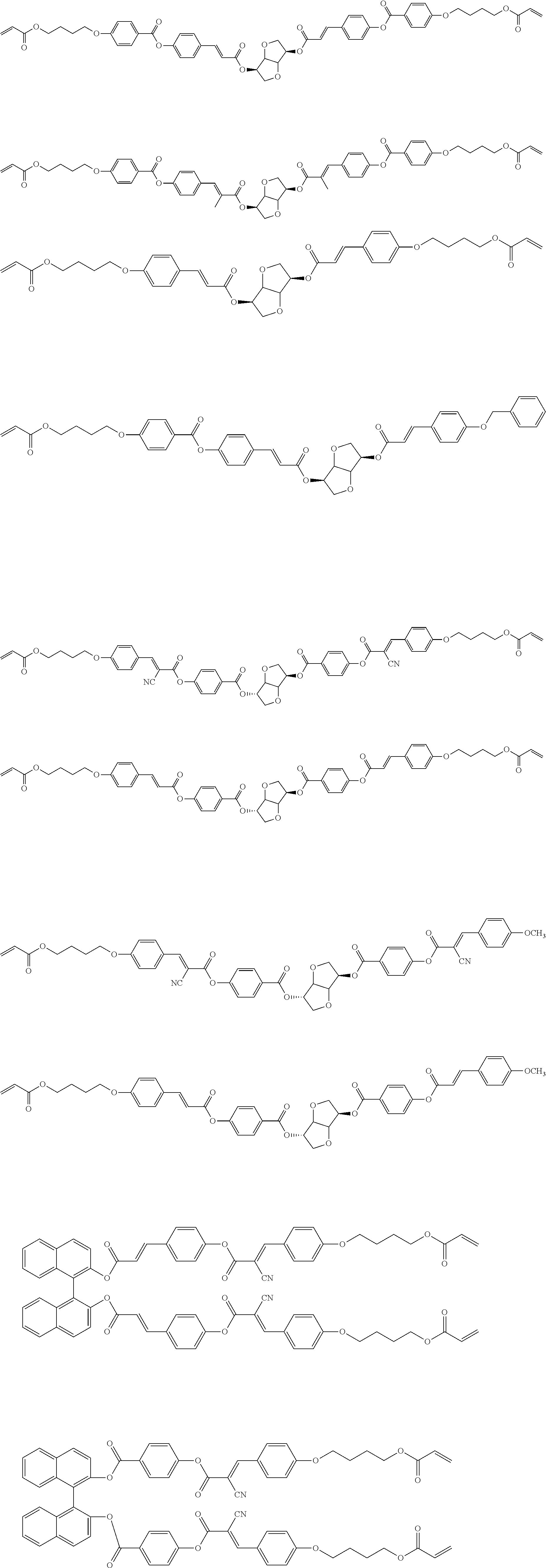

The binaphthyl compound represented by the above chemical formula is an (R)-form or an (S)-form.

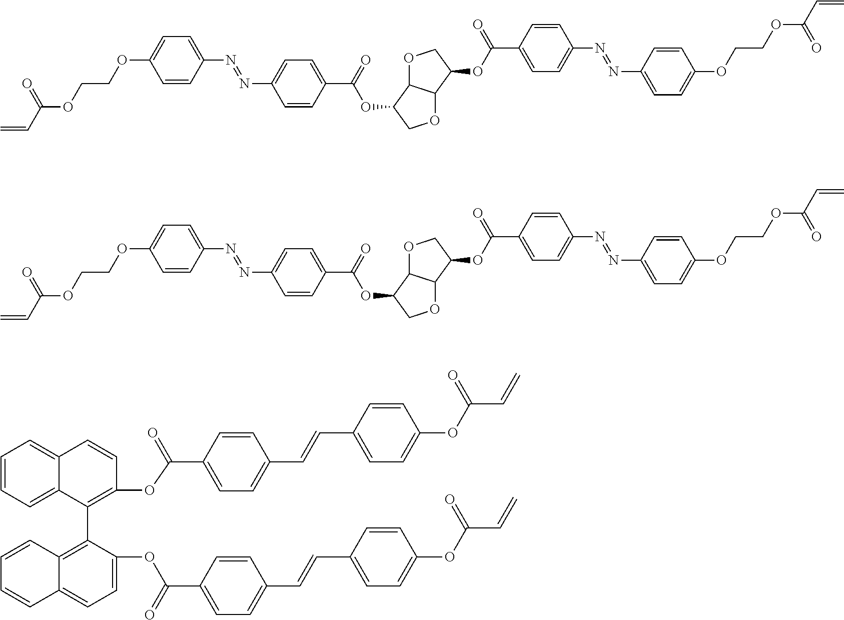

The polymerizable composition according to the embodiment of the present disclosure may contain one or two or more kinds of the chiral compounds represented by Formula (2).

From the viewpoint of controlling the aligning properties of the liquid crystal compound, improving the durability of the cured substance, and improving the reflection wavelength conversion ability, a proportion of the total amount of the chiral compound represented by Formula (2) is preferably 1% by mass to 15% by mass with respect to the total amount of solid contents of the polymerizable composition. The lower limit of the above-described proportion may be 2% by mass or 3% by mass. The upper limit of the above-described proportion may be 12% by mass.

The chiral compound may include a chiral compound including a binaphthyl skeleton. The chiral compound including a binaphthyl skeleton preferably includes a polymerizable group. Examples of the polymerizable group include the ethylenically unsaturated group and cyclic ether group described above. The chiral compound including a binaphthyl skeleton may be selected, for example, from a compound represented by General Formula (1), described in WO2020/049957A, an optically active compound represented by General Formula (1), described in JP2002-302487A, and a compound represented by General Formula (1), described in WO2019/181433A. The above-mentioned documents are incorporated herein by reference. Examples of the chiral compound including a binaphthyl skeleton include a compound represented by Formula (BN-1). The compound represented by Formula (BN-1) may be an R-form or an S-form, or may be a mixture of R-form and S-form.

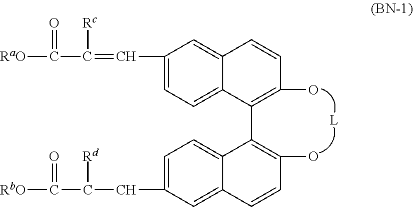

In Formula (BN-1), R^{a} and R^{b} each independently represent a monovalent organic group including a polymerizable group, R^{c} and R^{d} each independently represent a hydrogen atom, an alkyl group, or an alkoxycarbonyl group, and L represents a divalent linking group.

In Formula (BN-1), the monovalent organic group including a polymerizable group, represented by R^{a} and R^{b}, preferably has 2 to 20 carbon atoms, more preferably 3 to 16 carbon atoms, and still more preferably 4 to 10 carbon atoms. Examples of the monovalent organic group including a polymerizable group include an alkyl group including a polymerizable group and an aryl group including a polymerizable group. The alkyl group including a polymerizable group has a structure in which at least one hydrogen atom of the alkyl group is substituted with a polymerizable group. The aryl group including a polymerizable group has a structure in which at least one hydrogen atom of the aryl group is substituted with a polymerizable group. The monovalent organic group including a polymerizable group is preferably an alkyl group including a polymerizable group. Examples of the polymerizable group include the ethylenically unsaturated group and cyclic ether group described above. The polymerizable group is preferably an ethylenically unsaturated group, more preferably a (meth)acryloyloxy group, and still more preferably an acryloyloxy group (that is, CH₂═CH—COO—).

In Formula (BN-1), the alkyl group represented by R^{c} and R^{d} preferably has 1 to 30 carbon atoms, and more preferably has 1 to 20 carbon atoms. The alkyl group may include a substituent. Examples of the substituent include substituents described in paragraph 0026 of JP2002-302487A.

In Formula (BN-1), the alkoxycarbonyl group represented by R^{c} and R^{d} preferably has 2 to 30 carbon atoms, and more preferably has 2 to 20 carbon atoms. The alkoxycarbonyl group may include a substituent. Examples of the substituent include substituents described in paragraph 0027 of JP2002-302487A.

In Formula (BN-1), R^{c} and R^{d} are each independently preferably a hydrogen atom or an unsubstituted alkyl group, and more preferably a hydrogen atom.

In Formula (BN-1), the divalent linking group represented by L preferably has 1 to 30 carbon atoms, more preferably has 1 to 20 carbon atoms, still more preferably has 1 to 10 carbon atoms, and particularly preferably has 1 to 4 carbon atoms. Examples of the divalent linking group include an alkylene group. The divalent linking group may be selected, for example, from a divalent group represented by L in General Formula (1) described in JP2002-302487A. The divalent linking group is preferably an alkylene group, more preferably an alkylene group having 1 to 4 carbon atoms, and still more preferably —CH₂—.

The chiral compound including a binaphthyl skeleton may be selected, for example, from the specific examples of the chiral compound represented by Formula (2) described above. Specific examples of the chiral compound including a binaphthyl skeleton are shown below. However, the type of the chiral compound including a binaphthyl skeleton is not limited to the following specific examples.

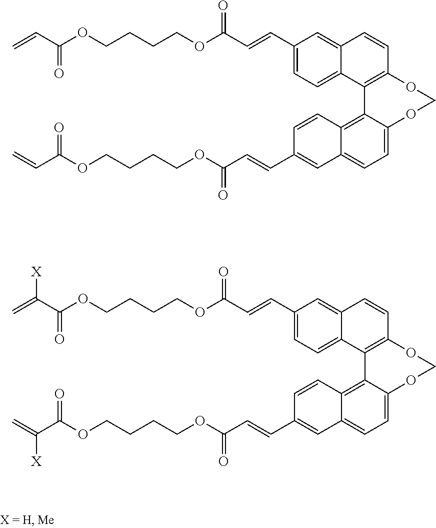

The chiral compound may include a chiral compound represented by Formula (CH1). A chemical structure of the chiral compound represented by Formula (CH1) can be changed by action of light.

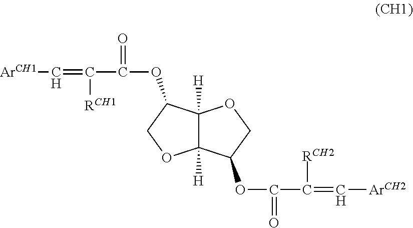

In Formula (CH1), Ar^{CH1} and Ar^{CH2} each independently represent an aryl group or a heteroaromatic ring group, and R^{CH1} and R^{CH2} each independently represent a hydrogen atom or a cyano group.

In Formula (CH1), it is preferable that Ar^{CH1} and Ar^{CH2} are each independently an aryl group. The aryl group preferably has 6 to 40 carbon atoms, and more preferably has 6 to 30 carbon atoms. The aryl group may have a substituent. As the substituent, a halogen atom, an alkyl group, an alkenyl group, an alkynyl group, an alkoxy group, a hydroxy group, an acyl group, an alkoxycarbonyl group, an aryloxycarbonyl group, an acyloxy group, a carboxy group, a cyano group, or a hetero ring group is preferable; and a halogen atom, an alkyl group, an alkenyl group, an alkoxy group, a hydroxy group, an acyloxy group, an alkoxycarbonyl group, or an aryloxycarbonyl group is more preferable.

As Ar^{CH1} and Ar^{CH2}, an aryl group represented by Formula (CH2) or Formula (CH3) is preferable.

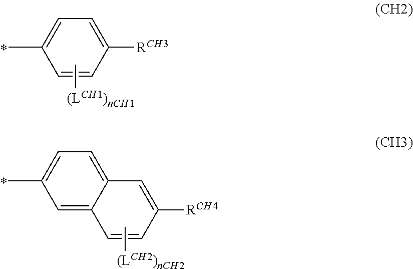

In Formula (CH2) and Formula (CH3), R^{CH3} and R^{CH4} each independently represent a hydrogen atom, a halogen atom, an alkyl group, an alkenyl group, an alkynyl group, an aryl group, a hetero ring group, an alkoxy group, a hydroxy group, an acyl group, an alkoxycarbonyl group, an aryloxycarbonyl group, an acyloxy group, a carboxy group, or a cyano group, L^{CH1} and L^{CH2} each independently represent a halogen atom, an alkyl group, an alkoxy group, or a hydroxy group, nCH1 represents an integer of 0 to 4, nCH2 represents an integer of 0 to 6, and * represents a bonding position with a carbon atom forming an ethylene unsaturated bond in Formula (CH1).

In Formula (CH2) and Formula (CH3), R^{CH3} and R^{CH4} are each independently preferably a hydrogen atom, a halogen atom, an alkyl group, an alkenyl group, an aryl group, an alkoxy group, a hydroxy group, an alkoxycarbonyl group, an aryloxycarbonyl group, or an acyloxy group, more preferably an alkoxy group, a hydroxy group, or an acyloxy group, and particularly preferably an alkoxy group.

In Formula (CH2) and Formula (CH3), L^{CH1} and L^{CH2} are each independently preferably an alkoxy group having 1 to 10 carbon atoms, or a hydroxy group.

nCH1 in Formula (CH2) is preferably 0 or 1.

nCH2 in Formula (CH3) is preferably 0 or 1.

The heteroaromatic ring group of Ar^{CH1} and Ar^{CH2} in Formula (CH1) preferably has 4 to 40 carbon atoms, and more preferably has 4 to 30 carbon atoms. The heteroaromatic ring group may have a substituent. As the substituent, a halogen atom, an alkyl group, an alkenyl group, an alkynyl group, an aryl group, an alkoxy group, a hydroxy group, an acyl group, an alkoxycarbonyl group, an aryloxycarbonyl group, an acyloxy group, or a cyano group is preferable, and a halogen atom, an alkyl group, an alkenyl group, an aryl group, an alkoxy group, or an acyloxy group is more preferable. As the heteroaromatic ring group, a pyridyl group, a pyrimidinyl group, a furyl group, or a benzofuranyl group is preferable, and a pyridyl group or a pyrimidinyl group is more preferable.

In Formula (CH1), it is preferable that R^{CH1} and R^{CH2} are each independently a cyano group.

For example, the chiral compound may also be selected from compounds described in WO2017/199812A, JP2002-338668A, WO2018/146995A, and WO2020/049957A. Each of the above-mentioned documents is incorporated herein by reference.

The polymerizable composition according to the embodiment of the present disclosure may contain one or two or more kinds of the chiral compounds.

From the viewpoint of controlling the aligning properties of the liquid crystal compound, improving the durability of the cured substance, and improving the reflection wavelength conversion ability, a content of the chiral compound in the polymerizable composition is preferably 1 part by mass to 15 parts by mass, more preferably 2 parts by mass to 15 parts by mass, and still more preferably 3 parts by mass to 12 parts by mass with respect to 100 parts by mass of the liquid crystal compound.

(Component of Polymerizable Composition: Polymerization Initiator)

It is preferable that the polymerizable composition according to the embodiment of the present disclosure further contains a polymerization initiator. Examples of the polymerization initiator include a radical polymerization initiator and a cationic polymerization initiator. Examples of the polymerization initiator also include a photopolymerization initiator. Examples of the photopolymerization initiator include a photoradical polymerization initiator and a photocationic polymerization initiator.

Examples of the photopolymerization initiator include α-carbonyl compounds (for example, U.S. Pat. Nos. 2,367,661A and 2,367,670A), acyloin ether compounds (U.S. Pat. No. 2,448,828A), α-hydrocarbon-substituted aromatic acyloin compounds (U.S. Pat. No. 2,722,512A), polynuclear quinone compounds (for example, U.S. Pat. Nos. 3,046,127A and 2,951,758A), combinations of triarylimidazole dimer and p-aminophenyl ketone (U.S. Pat. No. 3,549,367A), and oxadiazole compounds (U.S. Pat. No. 4,212,970A). Examples of the photopolymerization initiator also include acridine compounds and phenazine compounds (JP1985-105667A (JP-S60-105667A) and U.S. Pat. No. 4,239,850A).

Examples of a preferred photoradical polymerization initiator include α-hydroxyalkylphenone compounds, α-aminoalkylphenone compounds, and acylphosphine oxide compounds.

Examples of a preferred photocationic polymerization initiator include iodonium salt compounds and sulfonium salt compounds.

The polymerizable composition according to the embodiment of the present disclosure may contain one or two or more kinds of the polymerization initiators.

From the viewpoint of improving the durability of the cured substance, a proportion of the total amount of the polymerization initiator is preferably 0.03% by mass to 7% by mass with respect to the total amount of solid contents of the polymerizable composition.

(Component of Polymerizable Composition: Surfactant)

It is preferable that the polymerizable composition according to the embodiment of the present disclosure further contains a surfactant. The surfactant can contribute to stabilization and speeding up of the formation of the liquid crystal phase.

Examples of the surfactant include a cationic surfactant, an anionic surfactant, an amphoteric surfactant, and a nonionic surfactant. Examples of the surfactant also include a fluorine-containing (meth)acrylate-based polymer. Examples of the fluorine-containing (meth)acrylate-based polymer which can be used as the surfactant include polymers described in paragraphs 0018 to 0043 of JP2007-272185A. Examples of the surfactant also include compounds represented by General Formulae (X1) to (X3), described in WO2011/162291A, compounds represented by General Formula (I), described in paragraphs 0082 to 0090 of JP2014-119605A, and compounds described in paragraphs 0020 to 0031 of JP2013-47204A.

The polymerizable composition according to the embodiment of the present disclosure may contain one or two or more kinds of the surfactants.

From the viewpoint of stabilizing and speeding up the formation of the liquid crystal phase, a proportion of the total amount of the surfactant is preferably 0.001% by mass to 10% by mass, and more preferably 0.05% by mass to 3% by mass with respect to the total amount of solid contents of the polymerizable composition.

(Component of Polymerizable Composition: Solvent)

The polymerizable composition according to the embodiment of the present disclosure may further contain a solvent. Examples of the solvent include a ketone compound (for example, methyl ethyl ketone, methyl isobutyl ketone, and cyclohexanone), an alkyl halide compound, an amide compound, a sulfoxide compound, a heterocyclic compound, a hydrocarbon compound, an ester compound, and an ether compound. Examples of a preferred solvent include methyl ethyl ketone and cyclohexanone. The solvent preferably includes methyl ethyl ketone and cyclohexanone.

The polymerizable composition according to the embodiment of the present disclosure may contain one or two or more kinds of the solvents.

The content of the solvent is preferably an amount in which the proportion of the total amount of solid contents of the polymerizable composition is 5% by mass to 50% by mass (preferably 10% by mass to 40% by mass) with respect to the total amount of the polymerizable composition. In other words, a proportion of the total amount of the solvent is preferably 50% by mass to 95% by mass, and more preferably 60% by mass to 90% by mass with respect to the total amount of the polymerizable composition.

(Component of Polymerizable Composition: Crosslinking Agent)

The polymerizable composition according to the embodiment of the present disclosure may further contain a crosslinking agent. The crosslinking agent improves the durability of the cured substance.

Examples of the crosslinking agent include a crosslinking agent which cures with ultraviolet rays, heat, or humidity. Examples of the crosslinking agent include polyfunctional acrylate compounds (for example, trimethylolpropane tri(meth)acrylate and pentaerythritol tri(meth)acrylate), epoxy compounds (for example, glycidyl (meth)acrylate and ethylene glycol diglycidyl ether), aziridine compounds (for example, 2,2-bishydroxymethylbutanol-tris[3-(1-aziridinyl)propionate] and 4,4-bis(ethyleneiminocarbonylamino)diphenylmethane), isocyanate compounds (for example, hexamethylene diisocyanate and biuret-type isocyanate), and polyoxazoline compounds and alkoxysilane compounds having an oxazoline group in the side chain (for example, vinyltrimethoxysilane and N-(2-aminoethyl) 3-aminopropyltrimethoxysilane).

The polymerizable composition according to the embodiment of the present disclosure may contain one or two or more kinds of the crosslinking agents.

(Component of Polymerizable Composition: Other Components)

The polymerizable composition according to the embodiment of the present disclosure may further contain other components. The other components means a component other than the above-described components. Examples of the other components include a polymerization inhibitor, an antioxidant, a horizontal alignment agent, an ultraviolet absorber, a light stabilizer, a colorant, and metal oxide particles.

(Method for Producing Polymerizable Composition)

A method for producing the polymerizable composition according to the embodiment of the present disclosure is not limited. As the method for producing the polymerizable composition according to the embodiment of the present disclosure, for example, the polymerizable composition is produced by mixing components selected according to a desired composition. The apparatus used for mixing may be a known mixing apparatus.

(Application of Polymerizable Composition)

Examples of applications of the polymerizable composition according to the embodiment of the present disclosure include a color filter and a decorative film. The polymerizable composition according to the embodiment of the present disclosure is preferably used for producing a decorative film. The polymerizable composition according to the embodiment of the present disclosure may be applied to various uses after being cured. For example, in the decorative film, a cured substance obtained by curing the polymerizable composition according to the embodiment of the present disclosure is used as a liquid crystal layer. The cured substance is produced, for example, by applying and curing the polymerizable composition according to the embodiment of the present disclosure.

The applying of the polymerizable composition is carried out by a known method such as a roll coating method, a gravure printing method, and a spin coating method. Examples of the method of applying the polymerizable composition include a wire bar coating method, an extrusion coating method, a direct gravure coating method, a reverse gravure coating method, and a die-coating method. Examples of the method of applying the polymerizable composition include a method using an ink jet device. The type of the object to which the polymerizable composition is applied may be determined depending on the intended use. The applied polymerizable composition may be heated as necessary.

The curing of the polymerizable composition is carried out, for example, by irradiation with light or by heating. The curing of the polymerizable composition is preferably carried out by irradiation with light (that is, exposure). Examples of a light source used for the exposure include lamps (for example, a metal halide lamp, a tungsten lamp, a halogen lamp, a xenon lamp, a xenon flash lamp, a mercury lamp, a mercury-xenon lamp, and a carbon arc lamp), lasers (for example, semiconductor laser, helium neon laser, argon ion laser, helium cadmium laser, and yttrium aluminum garnet (YAG) laser), light emitting diodes, and cathode ray tube. The light used for the exposure preferably has a wavelength of 10 nm to 500 nm, and more preferably has a wavelength of 200 nm to 500 nm. An irradiation amount of light in the exposure is preferably 10 mJ/cm² to 1,500 mJ/cm² and more preferably 400 mJ/cm² to 1,200 mJ/cm². The exposure may be carried out while heating the polymerizable composition. A heating temperature of the polymerizable composition in the exposure is preferably 40° C. to 80° C. The exposure may be carried out in an environment of low oxygen concentration. The oxygen concentration in the exposure is preferably 1,500 ppm or less. The oxygen concentration in the exposure may be 1,000 ppm or less, 500 ppm or less, or 100 ppm or less.

<Decorative Film>

The decorative film according to the embodiment of the present disclosure includes a layer obtained by curing the polymerizable composition according to the embodiment of the present disclosure (hereinafter, it may be referred to as “liquid crystal layer” in the section of “Decorative film”).

(Liquid Crystal Layer)

The decorative film according to the embodiment of the present disclosure includes a liquid crystal layer. The liquid crystal layer is a layer obtained by curing the polymerizable composition according to the embodiment of the present disclosure. Aspects of the polymerizable composition used as a raw material of the liquid crystal layer are described in the section of “Polymerizable composition” above. A method for curing the polymerizable composition is described in the section of “Polymerizable composition” above.

The liquid crystal layer preferably has a maximal reflection wavelength in a wavelength range of 380 nm to 1,500 nm. The wavelength range including the maximal reflection wavelength is preferably 380 nm to 1,200 nm, more preferably 400 nm to 1,000 nm, and still more preferably 420 nm to 900 nm.

From the viewpoint of strength and durability, a thickness of the liquid crystal layer is preferably in a range of 0.2 μm to 150 μm, more preferably in a range of 0.5 μm to 100 μm, still more preferably in a range of 1 μm to 50 μm, and particularly preferably in a range of 1 μm to 10 μm.

(Base Material)

The decorative film according to the embodiment of the present disclosure may include a base material. The base material may be a support. Examples of the base material include known base materials used for molding such as three-dimensional molding and insert molding. From the viewpoint of ease of molding and chipping resistance, the base material is preferably a resin base material, and more preferably a resin film.

Examples of the base material include polyethylene terephthalate (PET), polyethylene naphthalate (PEN), an acrylic resin, a urethane resin, a urethane-acrylic resin, polycarbonate (PC), an acrylic-polycarbonate resin, triacetyl cellulose (TAC), a cycloolefin polymer (COP), and an acrylonitrile/butadiene/styrene copolymer resin (ABS resin). From the viewpoint of moldability and strength, the base material is preferably polyethylene terephthalate (PET), an acrylic resin, polycarbonate, or polypropylene, and more preferably polyethylene terephthalate (PET), an acrylic resin, or polycarbonate.

The base material may have a monolayer structure or a multilayer structure. Examples of the base material having a multilayer structure include a laminated film including an acrylic resin layer and a polycarbonate layer.

The base material may contain an additive as necessary. Examples of the additive include lubricants (for example, mineral oil, hydrocarbons, fatty acids, alcohols, fatty acid esters, fatty acid amides, metallic soaps, natural waxes, and silicone), inorganic flame retardants (for example, magnesium hydroxide and aluminum hydroxide), a halogen-based organic flame retardant, a phosphorus-based organic flame retardant, organic or inorganic fillers (for example, metal powder, talc, calcium carbonate, potassium titanate, glass fibers, carbon fibers, and wood powder), an antioxidant, an ultraviolet inhibitor, a lubricant, a dispersant, a coupling agent, a foaming agent, a colorant, and engineering plastics other than the above-described resins. Examples of the engineering plastics include polyolefins, polyesters, polyacetals, polyamides, and polyphenylene ethers.

As the base material, a commercially available product may be used. Examples of the commercially available product include TECHNOLLOY (registered trademark) series (acrylic resin film or acrylic resin/polycarbonate resin laminated film, manufactured by Sumitomo Chemical Co., Ltd.), ABS films (manufactured by Okamoto Industries, Inc.), ABS sheets (manufactured by SEKISUI SEIKEI CO., LTD.), Teflex (registered trademark) series (PET film, manufactured by TEIJIN FILM SOLUTIONS LIMITED), Lumirror (registered trademark) easily moldable type (PET film, manufactured by TORAY INDUSTRIES, INC), and Purethermo (polypropylene film, manufactured by Idemitsu Kosan Co., Ltd.).

A thickness of the base material is preferably 1 m or more, more preferably 10 m or more, still more preferably 20 m or more, and particularly preferably 30 m or more. The thickness of the base material is preferably 500 m or less, more preferably 200 m or less, and still more preferably 100 m or less.

(Alignment Layer)

The decorative film according to the embodiment of the present disclosure may include an alignment layer. The alignment layer is preferably in contact with the liquid crystal layer. The alignment layer is used, for example, for aligning the liquid crystal compound in the formation of the liquid crystal layer.

A thickness of the alignment layer is preferably in a range of 0.1 m to 10 m.

For example, the alignment layer is provided by a rubbing treatment of an organic compound (preferably a polymer), an oblique vapor deposition of an inorganic compound (for example, SiO₂), or a formation of a layer having a microgroove. For example, as the alignment layer, an alignment layer in which an alignment function occurs by application of an electric field, application of a magnetic field, or light irradiation is also known. Examples of a preferred alignment layer include a rubbing-treated alignment layer and a photoalignment layer.

The rubbing-treated alignment layer is an alignment layer to which aligning properties are imparted by a rubbing treatment. Examples of a polymer which can be used in the rubbing-treated alignment layer include a methacrylate-based copolymer, a styrene-based copolymer, polyolefin, polyvinyl alcohol, and modified polyvinyl alcohol, poly(N-methylol acrylamide), polyester, polyimide, a vinyl acetate copolymer, carboxymethyl cellulose, and polycarbonate, which are described in paragraph 0022 of JP1996-338913A (JP-H8-338913A). A silane coupling agent may be used as the polymer. As the polymer which can be used in the rubbing-treated alignment layer, a water-soluble polymer (for example, poly(N-methylol acrylamide), carboxymethyl cellulose, gelatin, polyvinyl alcohol, and modified polyvinyl alcohol) is preferable, gelatin, polyvinyl alcohol, or modified polyvinyl alcohol is more preferable, and polyvinyl alcohol or modified polyvinyl alcohol is still more preferable.

In a method of aligning the liquid crystal compound using the rubbing-treated alignment layer, for example, the liquid crystal compounds are aligned by coating a rubbing-treated surface of the rubbing-treated alignment layer with the polymerizable composition. Next, as necessary, by reacting the polymer contained in the alignment layer and the polymerizable compound contained in the liquid crystal layer or by crosslinking the polymer contained in the alignment layer using the crosslinking agent, the liquid crystal layer can be formed.

The rubbing treatment is performed, for example, by rubbing a surface of a film containing a polymer as a main component with paper or cloth in a certain direction. The general method of the rubbing treatment is described in, for example, “Handbook of Liquid crystals” (published by Maruzen, Oct. 30, 2000).

Examples of a method of changing a rubbing density include the method described in “Handbook of Liquid crystals” (published by Maruzen). The rubbing density (L) is quantified by Expression (A).

L=Nl(1+2πrn/60v) Expression (A):

In Expression (A), N is the number of times of rubbing, l is a contact length of a rubbing roller, π is a circular constant, r is a radius of the roller, n is a rotation speed (revolutions per minute: rpm) of the roller, and v is a stage moving speed (speed per second).

In order to increase the rubbing density, it is sufficient that the number of times of rubbing is increased, the contact length of the rubbing roller is increased, the radius of the roller is increased, the rotation speed of the roller is increased, or the stage moving speed is decreased. On the other hand, in order to decrease the rubbing density, it is sufficient that above-described conditions are reversed. With regard to conditions for the rubbing treatment, the description in JP4052558B may be referred to.

The photoalignment layer is an alignment layer to which aligning properties are imparted by light irradiation. Examples of a photoalignment material used for the photoalignment layer include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadiimide compounds having a photo alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. Azo compounds, photo-crosslinkable polyimides, polyamides, or esters are preferable.

The photoalignment layer is produced, for example, by subjecting a layer formed of the photoalignment material to irradiation with linearly polarized light or irradiation with non-polarized light. The “irradiation with linearly polarized light” is an operation for causing a photo-reaction of the photoalignment material. A wavelength of light used for the light irradiation is determined, for example, depending on the type of the photoalignment material. A peak wavelength of light used for the light irradiation is preferably 200 nm to 700 nm. The light used for the light irradiation is preferably ultraviolet rays having a peak wavelength of 400 nm or less.

Examples of a light source used for the light irradiation include lamps (for example, a tungsten lamp, a halogen lamp, a xenon lamp, a xenon flash lamp, a mercury lamp, a mercury-xenon lamp, and a carbon arc lamp), lasers (for example, semiconductor laser, helium neon laser, argon ion laser, helium cadmium laser, and yttrium aluminum garnet (YAG) laser), light emitting diodes, and cathode ray tube.

Examples of a method for obtaining the linearly polarized light include a method of using a polarizing plate (for example, iodine polarizing plate, dichroic coloring agent polarizing plate, and wire grid polarizing plate), a method of using a prismatic element (for example, Glan-Thompson prism) and a reflective type polarizer using Brewster's angle, and a method of using light emitted from a polarized laser light source. In addition, by using a filter and a wavelength conversion element, only light having a required wavelength may be irradiated selectively.

In a case where the linearly polarized light is used, a method of irradiating light perpendicularly or obliquely to the upper surface or the lower surface of the alignment layer is adopted. An incidence angle of the light is preferably 0° to 90° (that is, perpendicular), and more preferably 40° to 90°. In a case where the non-polarized light is used, the non-polarized light is obliquely irradiated to the upper surface or the lower surface of the alignment layer. An incidence angle of the non-polarized light is preferably 10° to 80°, more preferably 20° to 60°, and still more preferably 30° to 50°. An irradiation time is preferably 1 minute to 60 minutes and more preferably 1 minute to 10 minutes.

In the decorative film according to the embodiment of the present disclosure, even in a case where the alignment layer is not provided, by directly applying an alignment treatment (for example, a rubbing treatment) to a target layer (for example, the base material), the target layer can function as the alignment layer.

(Resin Layer)

The decorative film according to the embodiment of the present disclosure may include a resin layer. The resin layer is preferably disposed between the base material and the liquid crystal layer.

A thickness of the resin layer is preferably in a range of 0.2 m to 100 m, more preferably in a range of 0.5 m to 70 m, and still more preferably in a range of 1.0 m to 50 m.

An elastic modulus of the resin layer at 25° C. is preferably 0.000001 GPa to 3 GPa, more preferably 0.0001 GPa to 1 GPa, and still more preferably 0.00001 GPa to 0.5 GPa. The elastic modulus is measured with a nanoindenter device (for example, Nano Indenter G200, manufactured by KLA Corporation).

The resin layer preferably contains a binder resin as a main component. As the binder resin, a transparent resin is preferable, and a resin having a total light transmittance of 80% or more is more preferable. The total light transmittance can be measured with a spectrophotometer (for example, spectrophotometer UV-2100 manufactured by Shimadzu Corporation).

Examples of the binder resin include acrylic resins, silicone resins, polyester, urethane resins, and polyolefin. The binder resin may be a homopolymer or a copolymer.

The resin layer may contain one kind or two or more kinds of the binder resins.

From the viewpoint of moldability, a content of the binder resin in the resin layer is preferably 5% by mass to 70% by mass, more preferably 10% by mass to 60% by mass, and still more preferably 20% by mass to 60% by mass with respect to the total mass of the resin layer.

A known pressure sensitive adhesive or adhesive may be used as the resin layer. Examples of the pressure sensitive adhesive include an acrylic pressure sensitive adhesive, a rubber-based pressure sensitive adhesive, and a silicone-based pressure sensitive adhesive. In addition, examples of the pressure sensitive adhesive also include acrylic pressure sensitive adhesives, ultraviolet (UV) curable pressure sensitive adhesives, and silicone-based pressure sensitive adhesives described in “Chapters 2 of “Characterization evaluation of release paper, release film, and adhesive tape, and control technique thereof”, 2004, Information Mechanism”. The “acrylic pressure sensitive adhesive” refers to a pressure sensitive adhesive including a polymer (that is, a (meth)acrylicpolymer) of a (meth)acrylic monomer. In a case where the resin layer contains a pressure sensitive adhesive, the resin layer may further contain a viscosity imparting agent. Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive. From the viewpoint of higher adhesive force, a urethane resin adhesive or a silicone adhesive is preferable.

The resin layer is formed of, for example, a composition for forming the resin layer. The composition for forming the resin layer is prepared, for example, by mixing raw materials of the resin layer. As a method for applying the composition for forming the resin layer, for example, the same method as the method of applying the polymerizable composition described above is used.

The resin layer may contain an additive as necessary. Examples of the additive include surfactants described in paragraph 0017 of JP4502784B and paragraphs 0060 to 0071 of JP2009-237362A, thermal polymerization inhibitors described in paragraph 0018 of JP4502784B (also referred to as a polymerization inhibitor; preferred examples thereof include phenothiazine), and additives described in paragraphs 0058 to 0071 of JP2000-310706.

(Colored Layer)

The decorative film according to the embodiment of the present disclosure may include a colored layer. The colored layer is a colored (that is, not colorless and transparent) layer. The colored layer is preferably an opaque colored layer (preferably, a colored layer having a total light transmittance of 10% or less).

The color of the colored layer may be black, gray, white, red, orange, yellow, green, blue, or violet. With a black-colored layer, for example, intensity of reflected light is low and a change in color is more emphasized. With a white colored layer, for example, light transmitted through the liquid crystal layer is reflected by the colored layer, and a change in tint using a complementary color is obtained. For example, in a case where the liquid crystal layer selectively reflects green light, it is possible to express a tint using a magenta color which is a complementary color thereof.

The colored layer may be a layer formed by curing a polymerizable compound, or may be a layer containing a polymerizable compound and a polymerization initiator. From the viewpoint of storage stability and adhesiveness between the colored layer and other layers, the colored layer is preferably a layer formed by curing a polymerizable compound and more preferably a layer formed by curing at least a bifunctional or trifunctional polymerizable compound which has at least one partial structure selected from the group consisting of a urethane bond and an alkyleneoxy group having 2 or 3 carbon atoms.

From the viewpoint of visibility, the colored layer preferably contains a colorant. From the viewpoint of durability, the colored layer preferably contains a pigment as the colorant. Examples of the colorant include a pigment and a dye, and a pigment is preferable. The pigment is preferably a pigment having a particle shape. Examples of the pigment include an inorganic pigment and an organic pigment.

Examples of the inorganic pigment include inorganic pigments described in paragraph 0015 and paragraph 0114 of JP2005-7765A. Specific examples of the inorganic pigment include white pigments (for example, titanium dioxide, zinc oxide, lithopone, light calcium carbonate, white carbon, aluminum oxide, aluminum hydroxide, and barium sulfate) and black pigments (for example, carbon black, titanium black, titanium carbon, iron oxide, and graphite). For example, known chromatic pigments such as iron oxide, barium yellow, cadmium red, and chrome yellow can also be used.

Examples of the organic pigment include organic pigments described in paragraph 0093 of JP2009-256572A. Specific examples of the organic pigment include red pigments such as C. I. Pigment Red 177, 179, 224, 242, 254, 255, and 264, yellow pigments such as C. I. Pigment Yellow 138, 139, 150, 180, and 185, orange pigments such as C. I. Pigment Orange 36, 38, and 71, green pigments such as C. I. Pigment Green 7, 36, and 58, blue pigments such as C. I. Pigment Blue 15:6, and violet pigments such as C. I. Pigment Violet 23.

As the pigment, the colored layer may contain particles of a pigment (so-called bright pigment) having light-transmitting property and light-reflecting property. In a case where a method for forming the colored layer includes a step of exposing the colored layer, the bright pigment is preferably used in a range that does not hinder the curing by exposure.

The colored layer may contain one kind or two or more kinds of colorants. The colored layer may contain particles of the inorganic pigment and particles of the organic pigment.

From the viewpoint of developing the target color tone (for example, suppressing whitening) and maintaining shape-following property of the colored layer to the mold, a content of the colorant in the colored layer is preferably 1% by mass to 50% by mass, more preferably 5% by mass to 50% by mass, and still more preferably 10% by mass to 40% by mass with respect to the total mass of the colored layer. The “whitening” means that the colored layer changes so as to exhibit a whitish tint with a matt tone.

The colored layer may contain a polymerizable compound. The polymerizable compound includes at least one polymerizable group. Examples of the polymerizable group include an ethylenically unsaturated group and an epoxy group, and from the viewpoint of curing properties, an ethylenically unsaturated group is preferable and a (meth)acryloxy group is more preferable. The polymerizable group is preferably a radically polymerizable group.

As the polymerizable compound, a bifunctional or trifunctional polymerizable compound (hereinafter, also referred to as a “specific polymerizable compound”) having at least one partial structure selected from the group consisting of a urethane bond, a urea bond, an alkyleneoxy group having 2 or 3 carbon atoms, and a hydrocarbon group having 6 to 12 carbon atoms is preferable, and a compound including a urethane bond in the partial structure is more preferable.

As the bifunctional or trifunctional polymerizable compound (hereinafter, also referred to as a “specific polymerizable compound 1”) having a urethane bond, a urethane oligomer is preferable. A nitrogen atom in the urethane bond may be two-substituted (one of the groups on the nitrogen atom is a hydrogen atom) or three-substituted. In addition, the specific polymerizable compound 1 preferably has a urethane resin chain.

As the urethane oligomer, urethane (meth)acrylate oligomer is preferable. Examples of the urethane (meth)acrylate oligomer include an aliphatic urethane (meth)acrylate and an aromatic urethane (meth)acrylate. For details, the reference can be made to Oligomer Handbook (edited by Junji Furukawa, The Chemical Daily Co., Ltd.), and the urethane oligomer described therein can be appropriately selected according to the purpose and used for forming the colored layer.

A molecular weight of the urethane oligomer which is one of the specific polymerizable compounds 1 is preferably 800 to 2,000 and more preferably 1,000 to 2,000.

As the urethane (meth)acrylate oligomer which is one of the specific polymerizable compounds 1, a commercially available product may be used. Examples of the commercially available product of the urethane (meth)acrylate oligomer include U-2PPA and UA-122P manufactured by Shin-Nakamura Chemical Co., Ltd.; CN964A85, CN964, CN959, CN962, CN963J85, CN965, CN982B88, CN981, CN983, CN991, CN991NS, CN996, CN996NS, CN9002, CN9007, CN9178, and CN9893 manufactured by Sartomer Japan Inc.; and EBECRYL230, EBECRYL270, EBECRYL284, EBECRYL4858, EBECRYL210, EBECRYL8402, EBECRYL8804, and EBECRYL8800-20R manufactured by DAICEL-ALLNEX LTD. (all product names). Note that, “EBECRYL” is a registered trademark.

From the viewpoint of improving dispersibility of the pigment contained in the colored layer, the colored layer may contain a dispersant. In a case where the colored layer contains a dispersant, dispersibility of the pigment in the formed colored layer is improved, and the color tone of the decorative film to be obtained can be uniformized.

The dispersant is preferably a polymer dispersant. Examples of the polymer dispersant include silicone polymers, acrylic polymers, and polyester polymers.

In a case where it is desired to impart heat resistance to the decorative film, silicone polymers such as a graft type silicone polymer are suitably used as the dispersant.

A weight-average molecular weight of the dispersant is preferably 1,000 to 5,000,000, more preferably 2,000 to 3,000,000, and still more preferably 2,500 to 3,000,000. In a case where the weight-average molecular weight is 1,000 or more, dispersibility of the pigment is further improved.

As the dispersant, a commercially available product may be used. Examples of the commercially available product include EFKA 4300 (acrylic polymer dispersant) manufactured by BASF Japan, HOMOGENOL L-18, HOMOGENOL L-95, and HOMOGENOL L-100 manufactured by Kao Corporation, Solsperse 20000 and Solsperse 24000 manufactured by Lubrizol Corporation, and DISPERBYK-110, DISPERBYK-164, DISPERBYK-180, and DISPERBYK-182 manufactured by BYK Chemie Japan. Note that, “HOMOGENOL”, “Solsperse”, and “DISPERBYK” are all registered trademarks.

The colored layer may contain one kind or two or more kinds of colorants. A content of the dispersant is preferably 1 part by mass to 30 parts by mass with respect to 100 parts by mass of the colorant.

The colored layer may contain a polymerization initiator. From the viewpoint of increasing sensitivity to exposure, the polymerization initiator is preferably a photopolymerization initiator. As the photopolymerization initiator, for example, polymerization initiators described in paragraphs 0031 to 0042 of JP2011-95716A and oxime-based polymerization initiators described in paragraphs 0064 to 0081 of JP2015-014783A can be used.

Specific examples of the photopolymerization initiator include 1-[4-(phenylthio)phenyl]-1,2-octanedione-2-(O-benzoyloxime) (for example, IRGACURE (registered trademark) OXE-01 manufactured by BASF), [9-ethyl-6-(2-methylbenzoyl)-9H-carbazol-3-yl]ethan-1-one-1-(0-acetyloxime) (for example, IRGACURE (registered trademark) OXE-02 manufactured by BASF), 2-(dimethylamino)-2-[(4-methylphenyl)methyl]-1-[4-(4-morpholinyl)phenyl]-1-butanone (for example, IRGACURE (registered trademark) 379EG manufactured by BASF), 2-methyl-1-(4-methylthiophenyl)-2-morpholinopropan-1-one (for example, IRGACURE (registered trademark) 907 manufactured by BASF), 2-hydroxy-1-{4-[4-(2-hydroxy-2-methylpropionyl)benzyl]phenyl}-2-methyl-propan-1-one (for example, IRGACURE (registered trademark) 127 manufactured by BASF), 2-benzyl-2-dimethylamino-1-(4-morpholinophenyl)butanone-1 (for example, IRGACURE (registered trademark) 369 manufactured by BASF), 2-hydroxy-2-methyl-1-phenylpropan-1-one (for example, IRGACURE (registered trademark) 1173 manufactured by BASF), 1-hydroxycyclohexyl phenyl ketone (for example, IRGACURE (registered trademark) 184 manufactured by BASF), 2,2-dimethoxy-1,2-diphenylethan-1-one (for example, IRGACURE (registered trademark) 651 manufactured by BASF), product name: Lunar 6 which is an oxime ester-based polymerization initiator (manufactured by DKSH Japan), 2,4-diethylthioxanthone (for example, KAYACURE DETX-S manufactured by Nippon Kayaku Co., Ltd.), and DFI-091 and DFI-020 which are fluorene oxime-based polymerization initiator (both manufactured by DAITO CHEMIX Co., Ltd.).

Among these, from the viewpoint of increasing curing sensitivity, an initiator other than a halogen-containing polymerization initiator, such as a trichloromethyltriazine-based compound, is preferably used, and oxime-based polymerization initiators such as an α-aminoalkylphenone-based compound, an α-hydroxyalkylphenone-based compound, and an oxime ester-based compound are more preferable.

A content of the polymerization initiator is preferably 0.1 parts by mass to 15 parts by mass and more preferably 0.5 parts by mass to 10 parts by mass with respect to 100 parts by mass of the polymerizable compound.

From the viewpoint of reducing curing shrinkage of the colored layer, the colored layer preferably contains a binder resin. From the viewpoint of obtaining a target color tone, as the binder resin, a transparent resin is preferable, and specifically, a resin having a total light transmittance of 80% or more is preferable. The total light transmittance can be measured with a spectrophotometer (for example, spectrophotometer UV-2100 manufactured by Shimadzu Corporation).

Examples of the binder resin include acrylic resins, silicone resins, polyester resins, urethane resins, and olefin resins. Among these, from the viewpoint of transparency, acrylic resins, silicone resins, or polyester resins are preferable, and acrylic resins or silicone resins are more preferable. Furthermore, from the viewpoint of heat resistance, a silicone resin is preferable.

Examples of the acrylic resin include an acrylic acid homopolymer, a methacrylic acid homopolymer, an acrylic acid ester homopolymer, a methacrylic acid ester homopolymer, a copolymer of acrylic acid and other monomers, a copolymer of methacrylic acid and other monomers, a copolymer of acrylic acid ester and other monomers, a copolymer of methacrylic acid ester and other monomers, and a urethane-modified copolymer having a urethane skeleton in the side chain. Examples of the acrylic resin also include a glycidyl methacrylate adduct of a cyclohexyl methacrylate/methyl methacrylate/methacrylic acid copolymer, a random copolymer of benzyl methacrylate/methacrylic acid, a copolymer of allyl methacrylate/methacrylic acid, and a copolymer of benzyl methacrylate/methacrylic acid/hydroxyethyl methacrylate.

Examples of the silicone resin include methyl-based straight silicone resins, methylphenyl-based straight silicone resins, acrylic resin-modified silicone resins, ester resin-modified silicone resins, epoxy resin-modified silicone resins, and alkyd resin-modified silicone resins, and rubber-based silicone resins. Among these, methyl-based straight silicone resins, methylphenyl-based straight silicone resins, acrylic resin-modified silicone resins, or rubber-based silicone resins are preferable, and methyl-based straight silicone resins, methylphenyl-based straight silicone resins, or rubber-based silicone resins are more preferable.

As the silicone resin, a commercially available product may be used, and examples of the commercially available product include KR-300, KR-311, KR-251, X-40-2406M, and KR-282 manufactured by Shin-Etsu Chemical Co., Ltd.

Examples of the polyester resin include a linear saturated polyester synthesized from aromatic dibasic acid or an ester-forming derivative thereof, and diol or an ester-forming derivative thereof. Specific examples of the linear saturated polyester include polyethylene terephthalate, polyethylene isophthalate, polybutylene terephthalate, poly(1,4-cyclohexylene dimethylene terephthalate), and polyethylene-2,6-naphthalate.

From the viewpoint of reducing curing shrinkage of the colored layer, a content of the binder resin is preferably 5% by mass to 70% by mass, more preferably 10% by mass to 60% by mass, and still more preferably 20% by mass to 60% by mass with respect to the total mass of the colored layer. In addition, a proportion of the total amount of the binder resin to the total amount of the polymerizable compound including the specific polymerizable compound, that is, the total amount of the polymerizable compound/the total amount of the binder resin is preferably 0.3 to 1.5 and more preferably 0.5 to 1.0.

The colored layer may contain an additive as necessary. Examples of the additive include surfactants described in paragraph 0017 of JP4502784B and paragraphs 0060 to 0071 of JP2009-237362A, thermal polymerization inhibitor described in paragraph 0018 of JP4502784B (also referred to as a polymerization inhibitor; preferably phenothiazine), and other additives described in paragraphs 0058 to 0071 of JP2000-310706.

The colored layer is formed of, for example, a composition for forming the colored layer. The composition for forming the colored layer preferably contains the colorant, and more preferably contains the colorant and an organic solvent. In addition, the composition for forming the colored layer may further contain the above-described other components. The composition for forming the colored layer can be prepared, for example, by mixing an organic solvent, and components contained in the colored layer, such as the colorant. A content of components contained in the colored layer is described as the content (% by mass) with respect to the total mass of the colored layer, but in a case where these components are contained in the composition for forming the colored layer, the content thereof may be considered as the content (% by mass) with respect to the total solid content of the composition for forming the colored layer. In addition, in a case where the composition for forming the colored layer contains a pigment as the colorant, from the viewpoint of enhancing uniform dispersibility and dispersion stability of the pigment, it is preferable that a pigment dispersion liquid containing the pigment and a dispersant thereof is prepared in advance and the composition for forming the colored layer is prepared using the pigment dispersion liquid. As the composition for forming the colored layer, a composition prepared in advance by the above-described method may be used, a commercially available product or the like may be used, or a composition for forming the colored layer may be prepared immediately before coating.

Examples of the organic solvent include organic solvents such as esters, ethers, ketones, and aromatic hydrocarbons. In addition, as the organic solvent in the composition for forming the colored layer, methyl ethyl ketone, propylene glycol monomethyl ether, propylene glycol monomethyl ether acetate, cyclohexanone, cyclohexanol, methyl isobutyl ketone, ethyl lactate, methyl lactate, and the like, which are the same as Solvent described in paragraphs 0054 and 0055 of US2005/282073A, can also be suitably used. Among these, as the organic solvent in the composition for forming the colored layer, 1-methoxy-2-propyl acetate, methyl 3-ethoxypropionate, ethyl 3-ethoxypropionate, ethyl cellosolve acetate, ethyl lactate, butyl acetate, methyl 3-methoxypropionate, 2-heptanone, cyclohexanone, diethylene glycol monoethyl ether acetate (ethyl carbitol acetate), diethylene glycol monobutyl ether acetate (butyl carbitol acetate), propylene glycol methyl ether acetate, methyl ethyl ketone, and the like are preferably used. These organic solvents may be used alone, or two or more kinds thereof may be used in combination. In addition, a content of the organic solvent is not particularly limited, but is preferably 5% by mass to 90% by mass and more preferably 30% by mass to 70% by mass with respect to the total mass of the composition for forming the colored layer (for example, a coating liquid).

(Adhesive Layer)

From the viewpoint of adhesiveness to the housing to which the decorative film is attached, and adhesiveness between layers, the decorative film according to the embodiment of the present disclosure preferably includes an adhesive layer. Examples of the adhesive layer include a layer including a known pressure sensitive adhesive or adhesive.

Examples of the pressure sensitive adhesive include an acrylic pressure sensitive adhesive, a rubber-based pressure sensitive adhesive, and a silicone-based pressure sensitive adhesive. Examples of the pressure sensitive adhesive include acrylic pressure sensitive adhesives, ultraviolet (UV) curable pressure sensitive adhesives, and silicone-based pressure sensitive adhesives described in Chapters 2 of “Characterization evaluation of release paper, release film, and adhesive tape, and control technique thereof”, 2004, Information Mechanism. In a case where the adhesive layer contains a pressure sensitive adhesive, the adhesive layer may further contain a viscosity imparting agent.

Examples of the adhesive include a urethane resin adhesive, a polyester adhesive, an acrylic resin adhesive, an ethylene vinyl acetate resin adhesive, a polyvinyl alcohol adhesive, a polyamide adhesive, and a silicone adhesive. From the viewpoint of higher adhesive force, a urethane resin adhesive or a silicone adhesive is preferable.

It is preferable that a relationship between a thickness (T2) of the colored layer, a thickness (T3) of the liquid crystal layer (preferably, a cholesteric liquid crystal layer), and a thickness (T4) of the adhesive layer satisfies T4<10(T2+T3). By satisfying the above-described relationship, it is possible to obtain a decorative film which is a thin film and has excellent lustrousness and visibility. T4<8(T2+T3) is more preferable, T4<5(T2+T3) is still more preferable, and T4<3(T2+T3) is particularly preferable.

Examples of a method for forming the adhesive layer include a method of laminating a protective film on which the adhesive layer has been formed so that the adhesive layer and an object (for example, the liquid crystal layer, the alignment layer, or the colored layer) are in contact with each other, a method of laminating the adhesive layer alone so as to be in contact with an object (for example, the liquid crystal layer, the alignment layer, or the colored layer), and a method of applying a composition including the pressure sensitive adhesive or the adhesive to an object (for example, the liquid crystal layer, the alignment layer, or the colored layer). As a laminating method, a known method can be used. Preferred examples of an applying method include the same method as the method of applying the polymerizable composition described above.

From the viewpoint of achieving both pressure sensitive strength and handleability, a thickness of the adhesive layer is preferably 2 m to 40 m, more preferably 3 m to 25 m, still more preferably 4 m to 20 m, and particularly preferably 4 m to 15 km.

(Protective Film)

The decorative film according to the embodiment of the present disclosure may include a protective film as an outermost layer. The protective film is not particularly limited as long as the protective film is formed of a material having flexibility and good peelability, and examples thereof include a resin film. Examples of the resin film include a polyethylene film. The protective film is introduced into the decorative film, for example, by attaching the protective film to an object (for example, the liquid crystal layer). A method for attaching the protective film is not particularly limited, and examples thereof include a known attaching method, such as a method of laminating the protective film on the object (for example, the liquid crystal layer).

(Other Layers)

The decorative film according to the embodiment of the present disclosure may include other layers. Examples of the other layers include a self-repairing layer, an antistatic layer, an antifouling layer, an anti-electromagnetic wave layer, and a conductive layer, which are known as a layer for the decorative film. The other layers can be formed by a known method. Examples thereof include a method of applying a composition (composition for forming a layer) containing components included in these layers in a layered shape, and drying the composition.

(Layer Configuration of Decorative Film)

Specific examples of a layer configuration of the decorative film are shown below. However, the layer configuration of the decorative film is not limited to the following specific examples.

(1) base material/colored layer/alignment layer/liquid crystal layer/adhesive layer

(2) colored layer/base material/resin layer/alignment layer/liquid crystal layer

(Decoration Method)

The decorative film according to the embodiment of the present disclosure can decorate various articles. Examples of a decoration method include laminating and various molding processes. Examples of the molding process include three-dimensional molding and insert molding. Examples of the three-dimensional molding include heat molding, vacuum molding, pressure molding, and vacuum pressure molding.

The decorative film according to the embodiment of the present disclosure may be used for producing a decorative molded article. The decorative molded article is produced, for example, by molding the decorative film by a known method. Examples of the application of the decorative molded article include interior and exterior of electronic devices (for example, wearable devices and smartphones), interior and exterior of automobiles, interior and exterior of electronic products, and packaging containers.

### EXAMPLES

Hereinafter, the present disclosure will be more specifically described with reference to Examples. The scope of the present disclosure is not limited to the specific examples shown below.

### Example 1

(Polymerizable Composition 1)

A polymerizable composition 1 containing the following components was prepared.
First liquid crystal compound (MLC—1): 85 parts by mass
Second liquid crystal compound (LC—1): 15 parts by mass
Chiral compound (C—1): 7 parts by mass
Surfactant (S-1): 0.36 parts by mass
Solvent (mixture of methyl ethyl ketone (85% by mass) and cyclohexanenone (15% by mass)): amount at which the proportion of the total amount of solid contents was 25% by mass with respect to the total amount of the polymerizable composition 1

MLC—1 is represented by the following chemical formula. In the following chemical formula, Me represents a methyl group.

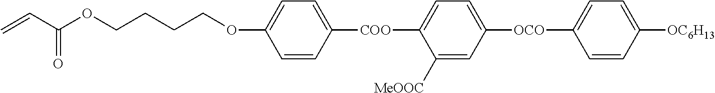

MLC—1 was produced according to the following reaction formula. In the following reaction formula, Me represents a methyl group, Ms represents a methylsulfonyl group, and Et represents an ethyl group.

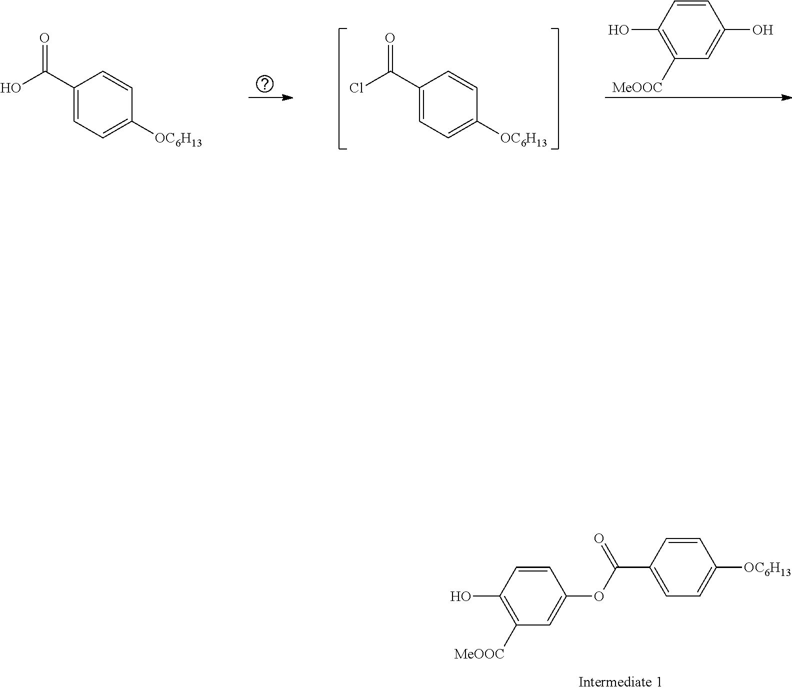

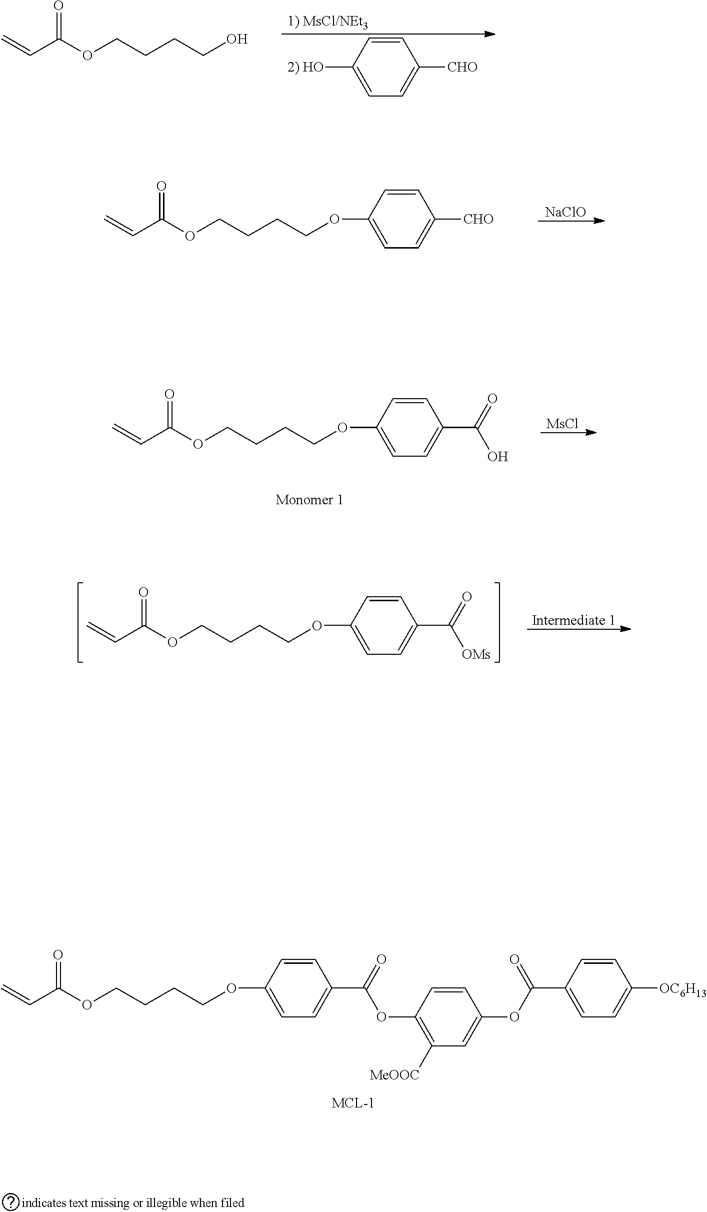

The intermediate 1 was produced by the following method. 30.0 g of p-(hexyloxy)benzoic acid (manufactured by Tokyo Chemical Industry Co., Ltd.), 39 mL of toluene (manufactured by FUJIFILM Wako Pure Chemical Corporation), and 104 μL of N,N-dimethylformamide (manufactured by FUJIFILM Wako Pure Chemical Corporation) were charged into a 500 mL three-neck flask, 16.9 g of thionyl chloride (manufactured by FUJIFILM Wako Pure Chemical Corporation) was added dropwise thereto at 45° C., and the mixture was stirred for 1 hour. Subsequently, 504 μL of methanesulfonic acid (manufactured by FUJIFILM Wako Pure Chemical Corporation), 34.0 g of methyl 2,5-dihydroxybenzoate (manufactured by Tokyo Chemical Industry Co., Ltd.), and 39 mL of butyl acetate (manufactured by FUJIFILM Wako Pure Chemical Corporation) were added thereto, and the mixture was stirred at 95° C. for 3 hours. 5.4 mL of methanol (manufactured by FUJIFILM Wako Pure Chemical Corporation) was added thereto and stirred at 35° C. for 30 minutes, 60 mL of water and 20 mL of butyl acetate were added thereto to extract an organic layer, and the obtained organic layer was washed with an aqueous sodium bicarbonate solution (6.0 g of sodium bicarbonate and 90 mL of water). 360 mL of methanol and 36 mL of water were added to the obtained solution, the mixture was stirred at 0° C. for 30 minutes, and the solid was separated by filtration and dried in a blast dryer at 40° C. for 18 hours to obtain the intermediate 1 as a white solid (43.9 g, yield: 87%).

The monomer 1 was produced according to the method described in JP2013-67603A.

MLC—1 was produced by the following method. 2.37 g of methanesulfonyl chloride (manufactured by FUJIFILM Wako Pure Chemical Corporation) and 8.2 mL of ethyl acetate (manufactured by FUJIFILM Wako Pure Chemical Corporation) were charged into a 300 mL three-neck flask, 5.22 g of the monomer 1, 104 mg of di-t-butyl hydroxytoluene (BHT, manufactured by FUJIFILM Wako Pure Chemical Corporation), 5.0 mL of ethyl acetate, 4.8 mL of tetrahydrofuran (manufactured by FUJIFILM Wako Pure Chemical Corporation), and 2.72 g of diisopropylethylamine (manufactured by FUJIFILM Wako Pure Chemical Corporation) were added dropwise thereto at 0° C., and the mixture was stirred for 30 minutes. 201 μL of N-methylimidazole (manufactured by FUJIFILM Wako Pure Chemical Corporation), 7.00 g of the intermediate 1, and 13 mL of ethyl acetate were added thereto, 2.13 g of triethylamine (manufactured by FUJIFILM Wako Pure Chemical Corporation) was added dropwise thereto, and the mixture was stirred at room temperature for 2 hours. 1.2 mL of methanol was added thereto, the mixture was stirred at room temperature for 30 minutes, and 14 mL of ethyl acetate and 10 mL of water were added thereto to extract an organic layer. The obtained organic layer was washed with 33 mL of water, 0.56 mL of acetic acid (manufactured by FUJIFILM Wako Pure Chemical Corporation), and 1.6 g of salt, 62 mL of methanol and 21 mL of water were added thereto, and the mixture was stirred at 0° C. for 30 minutes. The solid was separated by filtration and dried in a blast dryer at 40° C. for 18 hours to obtain MLC—1 as a white solid (10.6 g, yield: 91%).

LC—1 is represented by the following chemical formula.

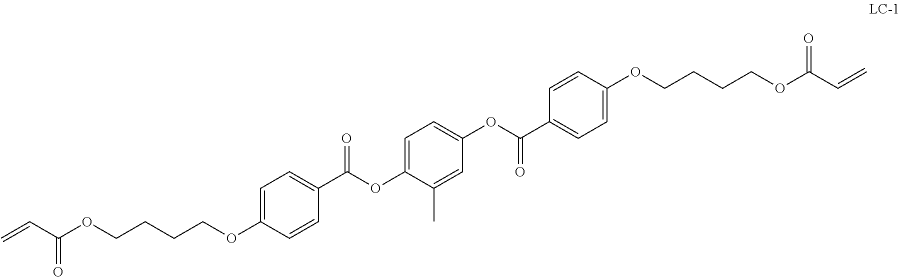 [SMILES: C=CC(=O)OCCCCOc1ccc(C(=O)Oc2ccc(OC(=O)c3ccc(OCCCCOC(=O)C=C)cc3)c(C)c2)cc1]

C—1 is represented by the following chemical formula.

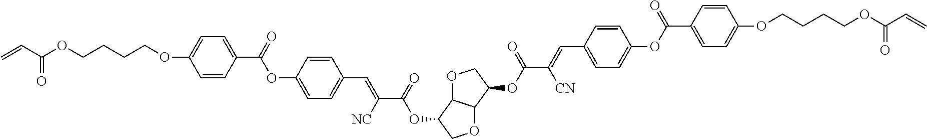 [SMILES: C=CC(=O)OCCCCOc1ccc(C(=O)Oc2ccc(/C=C(\C#N)C(=O)O[C@H]3COC4C3OC[C@H]4OC(=O)/C(C#N)=C/c3ccc(OC(=O)c4ccc(OCCCCOC(=O)C=C)cc4)cc3)cc2)cc1]

C—1 was produced according to the following reaction formula. In the following reaction formula, Ms represents a methylsulfonyl group and Et represents an ethyl group.

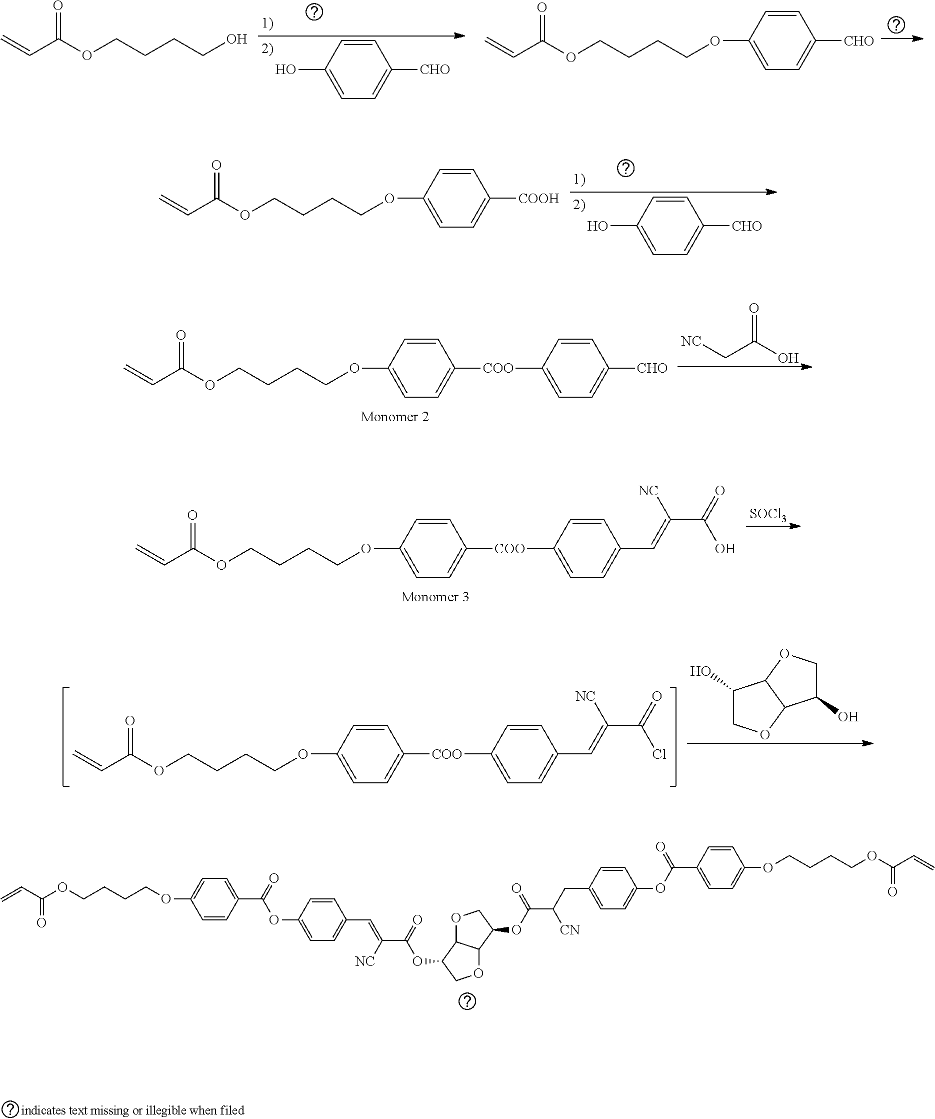

The monomer 2 was produced according to the method described in JP2013-67603A.

The monomer 3 was produced by the following method.

27.0 g of the monomer 2, 57 mL of ethyl acetate (manufactured by FUJIFILM Wako Pure Chemical Corporation), 18 mL of N,N-dimethylacetamide (DMAc, manufactured by FUJIFILM Wako Pure Chemical Corporation), 9.37 g of cyanoacetic acid (manufactured by FUJIFILM Wako Pure Chemical Corporation), 0.45 g of nitrobenzene (manufactured by FUJIFILM Wako Pure Chemical Corporation), 0.68 g of aniline (manufactured by FUJIFILM Wako Pure Chemical Corporation), 0.08 g of BHT, and 0.23 g of 2,2,6,6-tetramethylpiperidine 1-oxyl (TEMPO, manufactured by FUJIFILM Wako Pure Chemical Corporation) were charged into a 500 mL three-neck flask, and the mixture was stirred at 65° C. for 3 hours. 216 mL of methanol was added thereto, the mixture was stirred for 10 minutes, and 190 mL of methanol was further added thereto. The temperature was lowered to 0° C., the mixture was stirred for 30 minutes, and the solid was separated by filtration. The solid was dried in a blast dryer at 40° C. for 16 hours to obtain the monomer 3 as a white solid (29.0 g, yield: 91%).

C—1 was produced by the following method.

26.2 g of the monomer 3, 34 mL of DMAc, 13 mL of ethyl acetate, 9.20 g of diisopropylethylamine, 0.06 g of BHT, and 0.04 g of TEMPO were charged into a 500 mL three-neck flask. 5.17 g of N-methylimidazole and 4.0 g of isosorbide were added thereto, and the internal temperature was set to 0° C. A 34 mL ethyl acetate solution of 12.3 g of tosyl chloride (manufactured by FUJIFILM Wako Pure Chemical Corporation) was added dropwise thereto, and the mixture was stirred at room temperature for 2 hours. 45 mL of ethyl acetate, 80 mL of water, and 1.2 mL of concentrated hydrochloric acid were added thereto and stirred to extract an organic layer, and the obtained organic layer was washed with 135 mL of water. 240 mL of methanol was added thereto, the mixture was stirred at 0° C. for 30 minutes, and the solid was separated by filtration. The solid was dried in a blast dryer at 40° C. for 16 hours to obtain C—1 as a white solid (24.5 g, yield: 91%).

S-1 is represented by the following chemical formula.

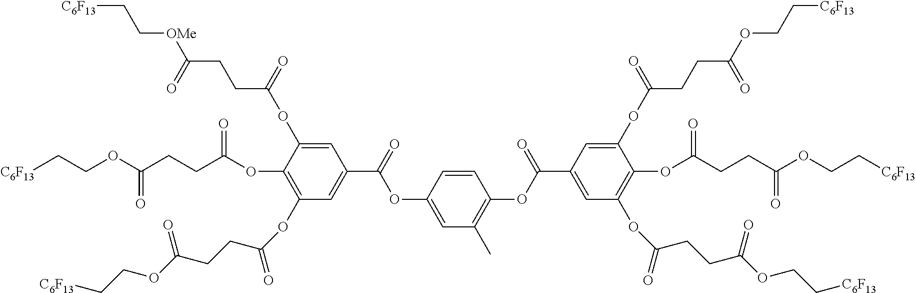

(Evaluation: Stretchability)

A coating liquid for forming an alignment layer, having the following composition, was prepared.
Modified polyvinyl alcohol 1: 2.63 parts by mass
Citric acid ester (AS3, manufactured by SANKYO CHEMICAL Co., Ltd.): 0.05 parts by mass
Glutaraldehyde: 0.13 parts by mass
Photopolymerization initiator (Omnirad 2959, manufactured by IGM Resins B.V.): 0.20 parts by mass
Water: 67.90 parts by mass
Methanol: 29.10 parts by mass

The modified polyvinyl alcohol 1 is represented by the following chemical formula.

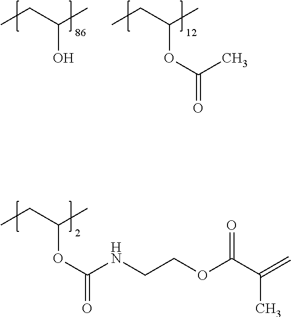

As a base material, TECHNOLLOY C000 (Sumika Acryl Co., Ltd., thickness: 100 m) was prepared. The coating liquid for forming an alignment layer was applied onto the base material with a wire bar (count #10), and dried at 100° C. for 2 minutes to obtain an alignment layer. The alignment layer was subjected to a rubbing treatment (rayon cloth, pressure: 0.1 kgf, rotation speed: 1,000 rpm, transportation speed: 10 m/min, number of times: 1 time) in a direction rotated counterclockwise by 3 degrees with respect to a short side direction of the base material.

The polymerizable composition 1 was applied onto the alignment layer under the following conditions, and heated to form a liquid crystal layer. A thickness of the liquid crystal layer was 2.4 m.
Applying unit: wire bar (count #7)
Heating conditions: 80° C. and 2 minutes

Next, the liquid crystal layer was exposed under the following conditions. The liquid crystal layer was cured by exposure. A thickness of the cured liquid crystal layer was 2.4 m.
Light source: metal halide lamp (GS Yuasa International Ltd., MAL625NAL, irradiation wavelength: 200 nm to 500 nm)
Illuminance: 150 mW/cm²
Irradiation amount: 500 mJ/cm²
Stage temperature: 60° C.
Oxygen concentration: ≤100 ppm

Next, the laminate including the base material, the alignment layer, and the liquid crystal layer was stretched according to the following conditions. In the following conditions, “MD” is an abbreviation for “Machine Direction” and “TD” is an abbreviation for “Transverse Direction”.
Device: Tensilon RTF-1310 (A&D Company)
Sample size: MD 50 mm×TD 10 mm
Stretching direction: MD
Distance between chucks: 30 mm
Heating conditions: 150° C. and 3 minutes
Tension speed: 1,000 mm/min

After the stretching, the laminate was visually observed, and an upper limit value of a stretching ratio at which the liquid crystal layer was not cracked was measured. Stretchability was evaluated according to the following standard based on the upper limit value of the stretching ratio at which the liquid crystal layer was not cracked. In the following standard, AA is most preferable. The evaluation results are shown in Table 1. AA to C are acceptable levels.
AA: 20%≤stretching ratio
A: 17.5%≤stretching ratio<20%
B: 15%≤stretching ratio<17.5%
C: 10%≤stretching ratio<15%
D: stretching ratio<10%

(Evaluation: Defects in Liquid Crystal Phase)

A laminate including a base material, an alignment layer, and a liquid crystal layer was prepared according to the method described in “Evaluation: stretchability” above. Next, the liquid crystal layer was observed using a polarization microscope under the following conditions, and the number of defects observed in a total of three visual field ranges was confirmed. In the observation of the liquid crystal layer using the polarization microscope, the defects were observed, for example, in a form of dots or lines. An average value x of the defects was calculated by dividing the total number of defects observed in the total of three visual field ranges by the number of visual field ranges (that is, 3).
Polarization microscope: ECLIPSE E600-POL (Nikon Corporation)
Objective lens: 10 times

Based on the average value x of the defects, the defects in the liquid crystal phase were evaluated according to the following standard. In the following standard, 6 is most preferable. The evaluation results are shown in Table 1. 2 to 6 are acceptable levels.
6:x≤3
5:3<x≤9
4: 9≤x≤15
3:15<x≤21
2: 21<x≤30
1:30<x

(Evaluation: Durability)

Under the following conditions, a base material was subjected to a rubbing treatment in a direction rotated counterclockwise by 3 degrees with respect to the short side direction.
Base material: COSMOSHINE A4100 (TOYOBO Co., Ltd.)
Rubbing treatment unit: rayon cloth
Pressure: 0.98 N
Rotation speed: 1,000 rpm
Transportation speed: 10 m/min
Number of times: 1 time

Next, under the following conditions, the polymerizable composition 1 was applied onto the rubbing-treated surface of the base material, and dried to form a liquid crystal layer on the base material. A thickness of the liquid crystal layer was 3 m.
Applying unit: wire bar (count #7)
Drying conditions: 85° C. and 2 minutes

Next, a patterning mask (hereinafter, referred to as “mask”) was closely attached to the surface of the base material. Under the following conditions, the liquid crystal layer was exposed through the mask and the base material, and the liquid crystal layer not shielded by the mask was subjected to a photoisomerization treatment.
Light source: metal halide lamp (GS Yuasa International Ltd., MAL625NAL, irradiation wavelength: 200 nm to 500 nm)
Irradiation amount: 10 mJ/cm²

Next, the mask was removed, and the laminate including the base material and the liquid crystal layer was placed on a hot plate at 70° C. Specifically, the base material and the liquid crystal layer were arranged on the hot plate in this order. The liquid crystal layer was exposed under the following conditions. The liquid crystal layer was cured by exposure. A thickness of the cured liquid crystal layer was 3 m.
Light source: metal halide lamp (GS Yuasa International Ltd., MAL625NAL, irradiation wavelength: 200 nm to 500 nm)
Illuminance: 200 mW/cm² to 500 mW/cm²
Irradiation amount: 1,000 mJ/cm²
Oxygen concentration: ≤1,000 ppm

Next, a glass substrate (OA-10G, Nippon Electric Glass Co., Ltd., thickness: 0.7 m), a double-sided pressure-sensitive adhesive sheet (G25, NEION Film Coatings Corp., thickness: 2 m), and a base material (COSMOSHINE A4360, TOYOBO Co., Ltd., thickness: 50 m) were attached to the laminate including the base material and the liquid crystal layer, thereby obtaining a laminate including, in the following order, the base material (A4360), the double-sided pressure-sensitive adhesive sheet (G25), the liquid crystal layer, the base material (A4100), the double-sided pressure sensitive adhesive sheet (G25), and the glass substrate (OA-10G). The double-sided pressure-sensitive adhesive sheet corresponds to the adhesive layer in the present disclosure.

Next, reflectivity of the obtained laminate was measured under the following conditions. After the reflectivity was measured, the laminate was heated in an oven at 80° C. After heating for 500 hours, reflectivity of the laminate was measured under the following conditions.
Measuring device: spectrophotometer (manufactured by JASCO Corporation, V-670) equipped with a large-scale integrating sphere device (manufactured by JASCO Corporation, ILV-471)
Measurement wavelength: 300 nm to 780 nm
Temperature of measurement environment: room temperature (23° C.)

A long shift amount Δλst was calculated by the following method based on the reflectivity of the laminate before the heating and the reflectivity of the laminate after the heating. First, in a graph in which the wavelength was shown on a horizontal axis and the reflectivity was shown on a vertical axis, the shortest wavelength among wavelengths showing the reflectivity of 50% of the maximum reflectivity Rmax was defined as λ1, and the second shortest wavelength was defined as λ2. Next, a central wavelength λs before the heating, a central wavelength λt after the heating, and a wavelength shift amount Δλst were calculated according to the following expressions. Examples of a reference relating to the method of calculating the wavelength shift amount Δλst include WO2017/018468A (for example, [0094]to [0096] and FIG. 5).

λs=(λ1+λ2)/2 Expression:

λt=(λ1+λ2)/2 Expression:

Δλst=|λs−λt| Expression:

Based on the wavelength shift amount Δλst, durability was evaluated according to the following standard. In the following standard, A is most preferable. The evaluation results are shown in Table 1. A to C are acceptable levels.
A: Δλst<5 nm
B: 5 nm≤Δλst<10 nm
C: 10 nm≤Δλst<20 nm
D: 20 nm≤Δλst

(Evaluation: Reflection Wavelength Conversion Ability)

The steps from the rubbing treatment of the base material to the curing of the liquid crystal layer were carried out according to the method described in “Evaluation: durability” above. Using a microscope (ECLIPSE E600-POL, Nikon Corporation) and a spectrophotometer (manufactured by JASCO Corporation, V-670) equipped with a large-scale integrating sphere device (manufactured by JASCO Corporation, ILV-471), a reflectivity of a region of the liquid crystal layer, subjected to a photoisomerization treatment, (hereinafter, referred to as “photoisomerization region” in this paragraph) and a reflectivity of a region of the liquid crystal layer, not subjected to the photoisomerization treatment, (hereinafter, referred to as “non-photoisomerization region” in this paragraph) were measured at room temperature (23° C.). In a graph in which the wavelength was shown on a horizontal axis and the reflectivity was shown on a vertical axis, the shortest wavelength among wavelengths showing the reflectivity of 50% of the maximum reflectivity Rmax was defined as λ1, and the second shortest wavelength was defined as λ2. Next, a central wavelength λs in the photoisomerization region, a central wavelength λt in the non-photoisomerization region, and a wavelength shift amount Δλst were calculated according to the following expressions.

λs=(λ1+λ2)/2 Expression:

λt=(λ1+λ2)/2 Expression:

Δλst=|λs−λt| Expression:

Based on the wavelength shift amount Δλst, reflection wavelength conversion ability was evaluated according to the following standard. In the following standard, 5 is most preferable. The evaluation results are shown in Table 1. 2 to 5 are acceptable levels.
5: 200 nm≤Δλst
4: 160 nm≤Δλst<200 nm
3: 120 nm≤Δλst<160 nm
2: 80 nm≤Δλst<120 nm
1: Δλst<80 nm

### Examples 2 to 11 and Comparative Examples 1 to 3

Evaluations were carried out according to the same procedures as in Example 1, except that the composition of the polymerizable composition was changed according to the description in Table 1. The evaluation results are shown in Table 1.

### Examples 12 to 20

Evaluations were carried out according to the same procedures as in Example 1, except that the type of the chiral compound was changed according to the description in Table 2. The evaluation results are shown in Table 2.

TABLE 1

| | First liquid | | | Second liquid | | | | | | Proportion | | | | |
|---|---|---|---|---|---|---|---|---|---|---|---|---|---|---|
| | crystal compound | | | crystal compound | | | Chiral compound | | | of mono- | Evaluation | | | |
| | | Number of | | | Number of | | | Number of | | functional | | Defects | | Refection |
| | | polymer- | Part | | polymer- | Part | | polymer- | Part | polymer- | | in liquid | | wavelength |
| | | izable | by | | izable | by | | izable | by | izable | Stretch- | crystal | Dura- | conversion |
| | Type | groups | mass | Type | groups | mass | Type | groups | mass | compound | ability | phase | bility | ability |
| Example 1 | MLC-1 | 1 | 85 | LC-1 | 2 | 15 | C-1 | 2 | 7 | 79% | A | 6 | A | 5 |
| Example 2 | MLC-2 | 1 | 85 | LC-1 | 2 | 15 | C-1 | 2 | 7 | 79% | A | 6 | A | 5 |
| Example 3 | MLC-3 | 1 | 85 | LC-1 | 2 | 15 | C-1 | 2 | 7 | 79% | A | 5 | A | 5 |
| Example 4 | MLC-4 | 1 | 85 | LC-1 | 2 | 15 | C-1 | 2 | 7 | 79% | A | 4 | A | 5 |
| Example 5 | MLC-5 | 1 | 85 | LC-1 | 2 | 15 | C-1 | 2 | 7 | 79% | A | 3 | A | 5 |
| Example 6 | MLC-6 | 1 | 85 | LC-1 | 2 | 15 | C-1 | 2 | 7 | 79% | A | 3 | A | 5 |
| Example 7 | MLC-7 | 1 | 85 | LC-1 | 2 | 15 | C-1 | 2 | 7 | 79% | A | 2 | A | 5 |
| Example 8 | MLC-1 | 1 | 65 | LC-1 | 2 | 35 | C-1 | 2 | 7 | 61% | C | 6 | A | 5 |
| Example 9 | MLC-1 | 1 | 75 | LC-1 | 2 | 25 | C-1 | 2 | 7 | 70% | B | 6 | A | 5 |
| Example 10 | MLC-1 | 1 | 100 | LC-1 | 2 | 0 | C-1 | 2 | 7 | 93% | AA | 5 | A | 5 |
| Example 11 | MLC-1 | MLC-1: | MLC-1: | LC-1 | 2 | 15 | C-1 | 2 | 7 | 79% | A | 6 | A | 5 |
| | | 1 | 42.5 | | | | | | | | | | | |
| | MLC-8 | MLC-8: | MLC-8: | | | | | | | | | | | |
| | | 1 | 42.5 | | | | | | | | | | | |
| Comparative | MLC-1 | 2 | 100 | LC-1 | 2 | 0 | C-1 | 2 | 7 | 0% | D | 2 | A | 5 |
| Example 1 | | | | | | | | | | | | | | |
| Comparative | MLC-2 | 1 | 100 | LC-1 | 2 | 0 | C-1 | 2 | 7 | 93% | AA | 1 | A | 5 |
| Example 2 | | | | | | | | | | | | | | |
| Comparative | MLC-1 | 1 | 55 | LC-1 | 2 | 45 | C-1 | 2 | 7 | 51% | D | 6 | A | 5 |
| Example 3 | | | | | | | | | | | | | | |

TABLE 2

| | First liquid | | | Second liquid | | | | | | Proportion | | | | |
|---|---|---|---|---|---|---|---|---|---|---|---|---|---|---|
| | crystal compound | | | crystal compound | | | Chiral compound | | | of mono- | Evaluation | | | |
| | | Number of | | | Number of | | | Number of | | functional | | Defects | | Refection |
| | | polymer- | Part | | polymer- | Part | | polymer- | Part | polymer- | | in liquid | | wavelength |
| | | izable | by | | izable | by | | izable | by | izable | Stretch- | crystal | Dura- | conversion |
| | Type | groups | mass | Type | groups | mass | Type | groups | mass | compound | ability | phase | bility | ability |
| Example 12 | MLC-1 | 1 | 85 | LC-1 | 2 | 15 | C-2 | 1 | 7 | 86% | A | 6 | B | 5 |
| Example 13 | MLC-1 | 1 | 85 | LC-1 | 2 | 15 | C-3 | 2 | 7 | 79% | A | 6 | A | 4 |
| Example 14 | MLC-1 | 1 | 85 | LC-1 | 2 | 15 | C-4 | 1 | 7 | 86% | A | 6 | B | 4 |
| Example 15 | MLC-1 | 1 | 85 | LC-1 | 2 | 15 | C-5 | 2 | 7 | 79% | A | 6 | A | 3 |
| Example 16 | MLC-1 | 1 | 85 | LC-1 | 2 | 15 | C-6 | 1 | 7 | 86% | A | 6 | B | 3 |
| Example 17 | MLC-1 | 1 | 85 | LC-1 | 2 | 15 | C-7 | 2 | 7 | 79% | A | 6 | A | 2 |
| Example 18 | MLC-1 | 1 | 85 | LC-1 | 2 | 15 | C-8 | 2 | 7 | 79% | A | 6 | A | 2 |
| Example 19 | MLC-1 | 1 | 85 | LC-1 | 2 | 15 | C-9 | 0 | 7 | 85% | A | 6 | C | 2 |
| Example 20 | MLC-1 | 1 | 85 | LC-1 | 2 | 15 | C-10 | 2 | 7 | 79% | A | 6 | A | 2 |

In Table 1 and Table 2, the “Proportion of monofunctional polymerizable compound” means a proportion of the total amount of the monofunctional polymerizable compound (that is, the compound including one polymerizable group) with respect to the total amount of the polymerizable compound (that is, the compound including at least one polymerizable group).

MLC—1 is represented by the following chemical formula. In the following chemical formula, Me represents a methyl group.

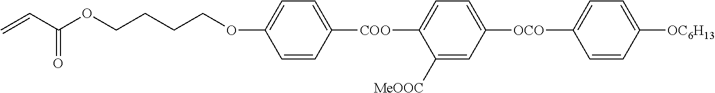

MLC—2 is represented by the following chemical formula. In the following chemical formula, Et represents an ethyl group.

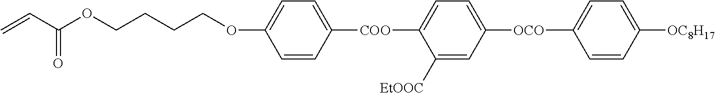

MLC—3 is represented by the following chemical formula. In the following chemical formula, Me represents a methyl group.

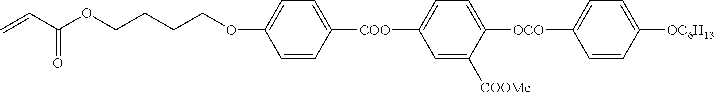

MLC—4 is represented by the following chemical formula. In the following chemical formula, Me represents a methyl group.

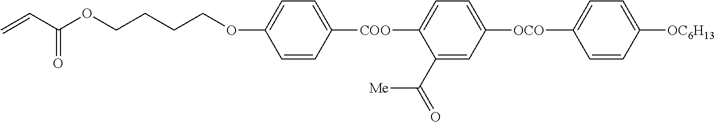

MLC—5 is represented by the following chemical formula. In the following chemical formula, Me represents a methyl group.

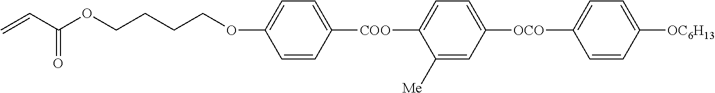

MLC—6 is represented by the following chemical formula. In the following chemical formula, tBu represents a tert-butyl group.

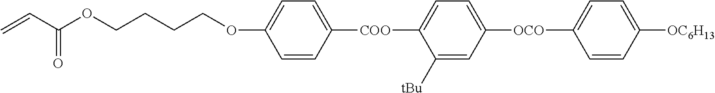

MLC—7 is represented by the following chemical formula.

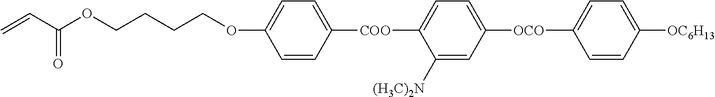

MLC—8 is represented by the following chemical formula. In the following chemical formula, Me represents a methyl group.

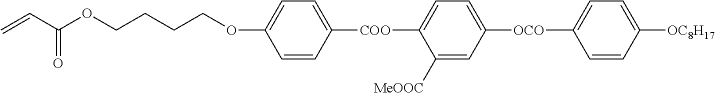

LCE-1 is represented by the following chemical formula.

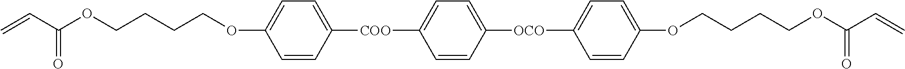

LCE-2 is represented by the following chemical formula.

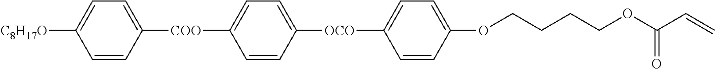

C—1 is represented by the following chemical formula.

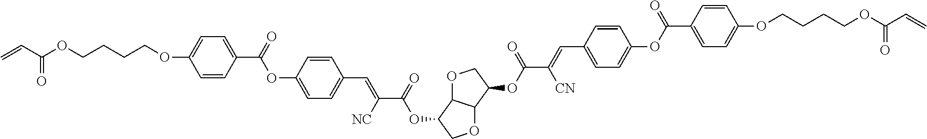 [SMILES: C=CC(=O)OCCCCOc1ccc(C(=O)Oc2ccc(/C=C(\C#N)C(=O)O[C@H]3COC4C3OC[C@H]4OC(=O)/C(C#N)=C/c3ccc(OC(=O)c4ccc(OCCCCOC(=O)C=C)cc4)cc3)cc2)cc1]

C—2 is represented by the following chemical formula.

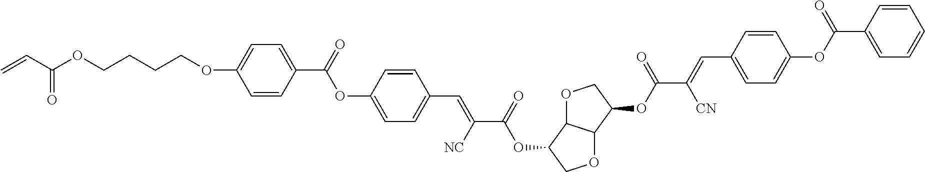 [SMILES: C=CC(=O)OCCCCOc1ccc(C(=O)Oc2ccc(/C=C(\C#N)C(=O)O[C@H]3COC4C3OC[C@H]4OC(=O)/C(C#N)=C/c3ccc(OC(=O)c4ccccc4)cc3)cc2)cc1]

C—3 is represented by the following chemical formula.

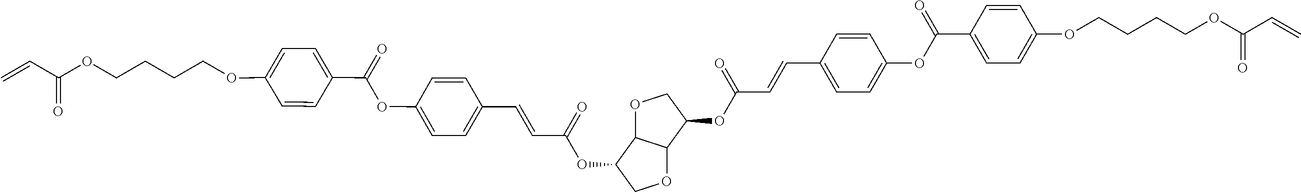 [SMILES: C=CC(=O)OCCCCOc1ccc(C(=O)Oc2ccc(/C=C/C(=O)O[C@H]3COC4C3OC[C@H]4OC(=O)/C=C/c3ccc(OC(=O)c4ccc(OCCCCOC(=O)C=C)cc4)cc3)cc2)cc1]

C—4 is represented by the following chemical formula.

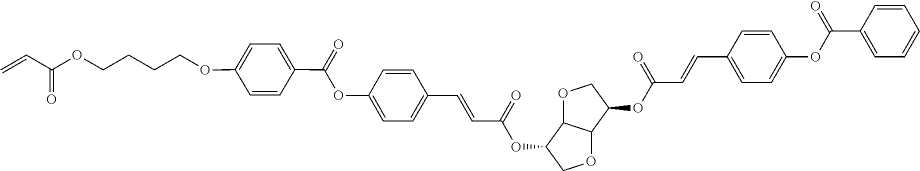 [SMILES: C=CC(=O)OCCCCOc1ccc(C(=O)Oc2ccc(/C=C/C(=O)O[C@H]3COC4C3OC[C@H]4OC(=O)/C=C/c3ccc(OC(=O)c4ccccc4)cc3)cc2)cc1]

C—5 is represented by the following chemical formula.

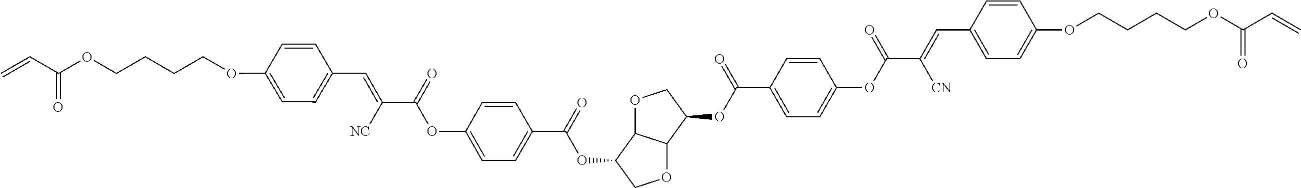 [SMILES: C=CC(=O)OCCCCOc1ccc(/C=C(\C#N)C(=O)Oc2ccc(C(=O)O[C@H]3COC4C3OC[C@H]4OC(=O)c3ccc(OC(=O)/C(C#N)=C/c4ccc(OCCCCOC(=O)C=C)cc4)cc3)cc2)cc1]

C—6 is represented by the following chemical formula.

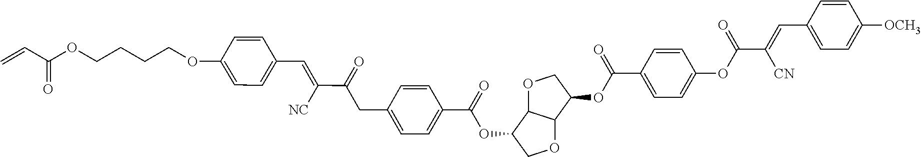 [SMILES: C=CC(=O)OCCCCOc1ccc(/C=C(\C#N)C(=O)Cc2ccc(C(=O)O[C@H]3COC4C3OC[C@H]4OC(=O)c3ccc(OC(=O)/C(C#N)=C/c4ccc(OC)cc4)cc3)cc2)cc1]

C—7 is represented by the following chemical formula.

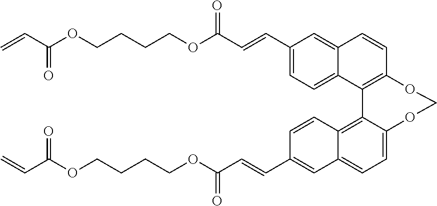 [SMILES: C=CC(=O)OCCCCOC(=O)/C=C/c1ccc2c3c(ccc2c1)OCOc1ccc2cc(/C=C/C(=O)OCCCCOC(=O)C=C)ccc2c1-3]

C—8 is represented by the following chemical formula.

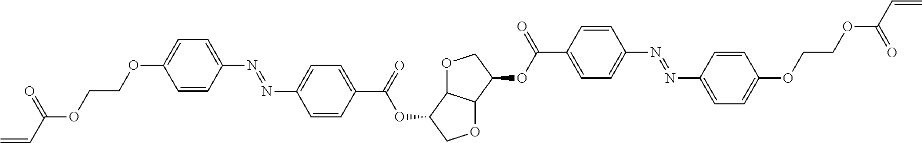 [SMILES: C=CC(=O)OCCOc1ccc(/N=N/c2ccc(C(=O)O[C@H]3COC4C3OC[C@H]4OC(=O)c3ccc(/N=N/c4ccc(OCCOC(=O)C=C)cc4)cc3)cc2)cc1]

C—9 is represented by the following chemical formula.

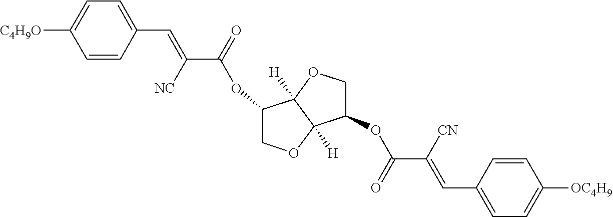

C—10 is represented by the following chemical formula. C—10 is available from BASF Japan.

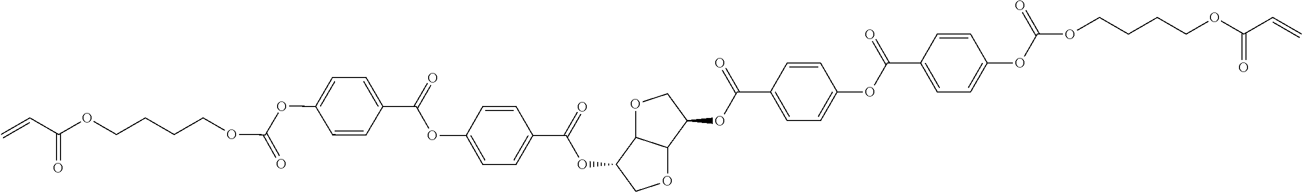 [SMILES: C=CC(=O)OCCCCOC(=O)Oc1ccc(C(=O)Oc2ccc(C(=O)O[C@H]3COC4C3OC[C@H]4OC(=O)c3ccc(OC(=O)c4ccc(OC(=O)OCCCCOC(=O)C=C)cc4)cc3)cc2)cc1]

In Table 1 and Table 2, it is shown that, as compared with Comparative Examples 1 to 3, Examples 1 to 20 exhibited excellent stretchability and reduced defects in the liquid crystal phase.

The disclosure of JP2021-040322 filed on Mar. 12, 2021 is incorporated in the present specification by reference.

All documents, patent applications, and technical standards described in the present specification are incorporated herein by reference to the same extent as in a case of being specifically and individually noted that individual documents, patent applications, and technical standards are incorporated by reference.

What is claimed is:

1. A polymerizable composition comprising:
a liquid crystal compound represented by Formula (1); and
a chiral compound,
wherein a proportion of a total amount of a compound including one polymerizable group is 60% by mass or more with respect to a total amount of a compound including at least one polymerizable group, 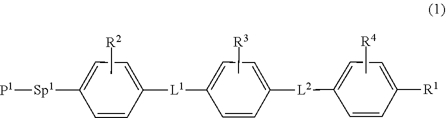
in Formula (1), R¹ to R⁴ each independently represent a hydrogen atom, an alkyl group having 1 to 20 carbon atoms, a group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—, or —CN,
where at least one of R², R³, or R⁴ is a substituent which is not a hydrogen atom,
L¹ and L² each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, or —C≡C—,
Sp¹ represents a single bond, an alkylene group having 1 to 20 carbon atoms, or a group having a structure in which at least one —CH₂— in an alkylene group having 2 to 20 carbon atoms is substituted with —O—, —S—, —NH—, —N(CH₃)—, —C(═O)—, —OC(═O)—, or —C(═O)O—, and
P¹ represents a polymerizable group represented by Formula (P-1) or Formula (P-2), 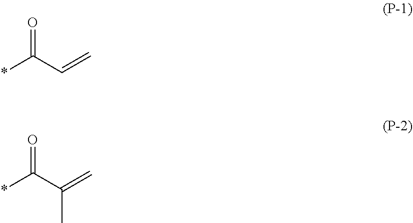
in Formula (P-1) and Formula (P-2), * represents a bonding position.

2. The polymerizable composition according to claim 1,
wherein, in Formula (1), at least one of R² or R³ is an alkyl group having 1 to 10 carbon atoms, an alkoxy group having 1 to 10 carbon atoms, —COOX¹, or —COX², where X¹ and X² each independently represent a linear alkyl group having 1 to 20 carbon atoms or a branched alkyl group having 3 to 20 carbon atoms.

3. The polymerizable composition according to claim 1,
wherein, in Formula (1), at least one of R² or R³ is —COOX¹ or —COX², where X¹ and X² each independently represent a linear alkyl group having 1 to 20 carbon atoms or a branched alkyl group having 3 to 20 carbon atoms.

4. The polymerizable composition according to claim 1,
wherein, in Formula (1), R³ is —COOX³, where X³ represents a linear alkyl group having 1 to 20 carbon atoms or a branched alkyl group having 3 to 20 carbon atoms.

5. The polymerizable composition according to claim 1,
wherein the liquid crystal compound represented by Formula (1) is a liquid crystal compound represented by Formula (1-1), 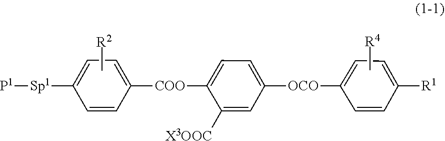
in Formula (1-1), R¹ has the same meaning as R¹ in Formula (1), R² has the same meaning as R² in Formula (1), R⁴ has the same meaning as R⁴ in Formula (1), Sp¹ has the same meaning as Sp¹ in Formula (1), P¹ has the same meaning as P¹ in Formula (1), and X³ represents a linear alkyl group having 1 to 20 carbon atoms or a branched alkyl group having 3 to 20 carbon atoms.

6. The polymerizable composition according to claim 1,
wherein the chiral compound includes a chiral compound represented by Formula (2), 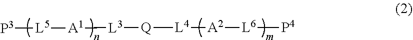
in Formula (2), L³ to L⁶ each independently represent a single bond, —COO—, —OCO—, —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CO—NH—, —NH—CO—, —CH₂O—, —OCH₂—, —CH₂—CH₂—O—, —OCH₂—CH₂—, —O—, —S—, —CO—, —CH═CH—, —C≡C—, or —N═N—,
A¹ and A² each independently represent a hydrocarbon ring group or a hetero ring group,
P³ and P⁴ each independently represent a hydrogen atom, an alkyl group having 1 to 20 carbon atoms, a group having a structure in which at least one —CH₂— in an alkyl group having 2 to 20 carbon atoms is substituted with —O—, —S—, —NH—, —N(CH₃)—, —C(═O)—, —OC(═O)—, or —C(═O)O—, —CN, or -Sp²-P⁵,
where Sp² represents a single bond, an alkylene group having 1 to 20 carbon atoms, or a group in which at least one —CH₂— in an alkylene group having 2 to 20 carbon atoms is substituted with —O—, —S—, —NH—, —N(CH₃)—, —C(═O)—, —OC(═O)—, or —C(═O)O—,
P⁵ represents a polymerizable group represented by Formula (P-3) or Formula (P-4), and
at least one of P³ or P⁴ is -Sp²-P⁵,
Q represents a divalent chiral source, and
n and m each independently represent an integer of 1 to 3,
where, in a case where n or m is an integer of 2 or more, a plurality of A¹'s may be the same or different from each other, a plurality of A²'s may be the same or different from each other, a plurality of L⁵'s may be the same or different from each other, and a plurality of L⁶'s may be the same or different from each other, 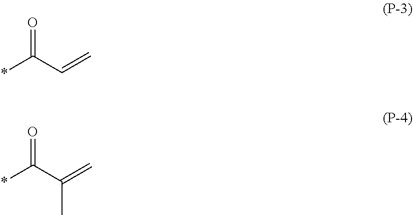
in Formula (P-3) and Formula (P-4), * represents a bonding position.

7. The polymerizable composition according to claim 6,
wherein, in Formula (2), at least one of L³, . . . , or L⁶ is —CH═CH—COO—, —OCO—CH═CH—, —CH═C(CN)—COO—, —OCO—C(CN)═CH—, —CH═CH—CO—, —CO—CH═CH—, —CH═N—, —N═CH—, —CH═CH—, or —N═N—.

8. The polymerizable composition according to claim 6,
wherein, in Formula (2), at least one of L³, . . . , or L⁶ is —CH═CH—COO—, —OCO—CH═CH—, —CH═C(CN)—COO—, or —OCO—C(CN)═CH—.

9. The polymerizable composition according to claim 6,
wherein, in Formula (2), Q is a divalent chiral source including a binaphthyl skeleton, an isosorbide skeleton, or an isomannide skeleton.

10. The polymerizable composition according to claim 6,
wherein, in Formula (2), Q is a divalent chiral source represented by Formula (Q-1) or Formula (Q-2), 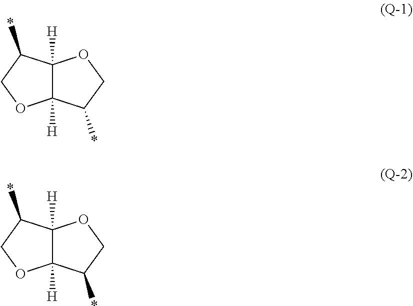 [SMILES: *[C@@H]1CO[C@H]2[C@@H]1OC[C@@H]2* ; *[C@@H]1CO[C@H]2[C@@H]1OC[C@H]2*]
in Formula (Q-1) and Formula (Q-2), * represents a bonding position.

11. The polymerizable composition according to claim 6,
wherein the chiral compound represented by Formula (2) is a chiral compound represented by Formula (2-1) or Formula (2-2), 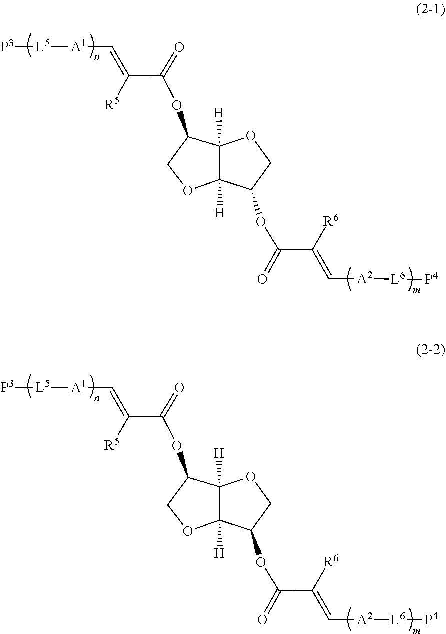
in Formula (2-1) and Formula (2-2), L⁵ has the same meaning as L⁵ in Formula (2), L⁶ has the same meaning as L⁶ in Formula (2), A¹ has the same meaning as A¹ in Formula (2), A² has the same meaning as A² in Formula (2), P³ has the same meaning as P³ in Formula (2), P⁴ has the same meaning as P⁴ in Formula (2), n has the same meaning as n in Formula (2), m has the same meaning as m in Formula (2), and R⁵ and R⁶ each independently represent a hydrogen atom, —CN, or an alkyl group having 1 to 10 carbon atoms.

12. The polymerizable composition according to claim 11,
wherein, in Formula (2-1) or Formula (2-2), R⁵ and R⁶ are —CN.

13. A decorative film comprising:
a layer obtained by curing the polymerizable composition according to claim 1.
